(19) United States
(12) Patent Application Publication
(10) Pub. No.: US 2024/0122206 A1
(43) Pub. Date: Apr. 18, 2024

(54) TWO-STAGE COOLING PROCESS FOR LARVAE PUREE

(71) Applicant: PROTIX B.V., Dongen (NL)

(72) Inventors: Aman PAUL, Dongen (NL); Nuria Martin TOME, Dongen (NL); Monika DALIM, Dongen (NL)

(73) Assignee: PROTIX B.V., Dongen (NL)

(21) Appl. No.: 18/264,085

(22) PCT Filed: Feb. 15, 2022
(86) PCT No.: PCT/NL2022/050075

§ 371 Date: Aug. 3, 2023

(30) Foreign Application Priority Data
Feb. 18, 2021 (NL) 2027590

(51) Int. Cl. A23J 1/02; A23J 3/04; A23K 10/20; A23K 20/147; A23K 40/00; A23L 13/00; A23L 33/17

(52) U.S. Cl. CPC A23J 1/02; A23J 3/04; A23K 10/20; A23K 20/147; A23K 40/00; A23L 13/00; A23L 33/17

(57) ABSTRACT

The invention relates to the batch-wise provision of insect paste, such as paste from minced and heated black soldier fly larvae. In addition, the invention relates to a cooling assembly for batch-wise provision of the insect paste. Moreover, the invention relates to an insect paste and to an insect paste obtainable with the method. Finally, the invention relates to a food product, food ingredient, feed product or feed ingredient comprising the insect paste.

### TECHNOLOGICAL FIELD

The invention relates to the batch-wise provision of insect paste, such as paste from minced and heated black soldier fly larvae. In addition, the invention relates to a cooling assembly for batch-wise provision of the insect paste. Moreover, the invention relates to an insect paste and to an insect paste obtainable with the method. Finally, the invention relates to a food product, food ingredient, feed product or feed ingredient comprising the insect paste.

### BACKGROUND OF THE INVENTION

Urban solid waste management is considered one of the most immediate and serious environmental problems confronting urban governments. The severity of this challenge will increase in the future given the trends of rapid urbanisation and growth in urban population. At present recycling organic waste material is still fairly limited, although this is by far the largest fraction of all generated municipal waste.

A fairly novel approach to bio-waste conversion is conversion by insect larvae, using for example the black soldier fly (Hermetia illucens), the house fly (Musca domestica), and the mealworm (i.e. the larval form of the mealworm beetle, Tenebrio molitor). Their popularity links to the promising opportunities of using the harvested larvae as a source of protein and fat for animal feed or food products, thus providing a valuable alternative to other (animal) sources of protein and fat.

Even though many people may perhaps dislike the idea of consuming whole insects, the use of insects as a source for (separated) fats and proteins, which are subsequently used in the preparation of food and feed is more acceptable. However, in order for insects to become a commercially viable nutrient source their production and processing should be carried out on a large scale, i.e. industrial scale, and the nutrient streams obtained should be free from unwanted flavours and discolorations and endangering levels of contaminants such as microbes.

Although large scale insect farms and large scale insect production facilities are already in use, the economical preparation of nutrient streams of sufficient quality remains a challenge. In the international patent application WO2014123420 a general method has been described for obtaining nutrient streams from insects or worms. Despite the fact that the methods disclosed therein are able to provide nutrient streams of sufficient quality, a need remains for further increasing the production rate of such methods, i.e. kg or liter product per time unit of operation, or time period required for producing a certain mass or volume of product, and for maintaining the quality and specifications of the nutrient streams obtained with such methods at the same time while increasing production yields and speed, or for improving quality and specifications of the nutrient streams obtained with such methods, while at the same time also improving on production speed.

Insects are commonly consumed as food in many cultures around the world. In European countries, insect proteins are gaining rapid acceptance as high value protein ingredients in animal diets. The European Union (EU) has already approved the inclusion of insect proteins in pet food and aquaculture feed formulations. Chicken meal and fish meal are common ingredients in pet food and aquaculture feed preparations, respectively. Insect proteins are increasingly being viewed as an alternative to chicken meal and fish meal in these markets. In January 2021, the European Food Safety Authority (EFSA) of the EU concluded that mealworms are safe for human consumption under the conditions specified by the applicant (Reference: efsa.onlinelibrary.wiley.com/doi/10.2903/j.efsa.2021.6343). Amongst all the insects being produced on industrial scale and in large-scale insect farms, black soldier fly (Hermetia illucens) larvae has gained special attention due to its ability to grow on a wide range of organic residues and due to their unique nutritional composition. The nutritional suitability of black soldier fly (BSF) larvae proteins in aquaculture and pet diets is well established.

The present invention aims to further improve the yield and quality of the nutrient streams obtained from insects by applying a new or improved method over methods known in the prior art. The invention is further aimed at the nutrient streams obtained with such methods.

### SUMMARY OF THE INVENTION

According to the inventors, an improved, i.e. faster with regard to cooling heated insect pulp to a temperature of below 10° C., method for providing insect paste is obtained, and an improved insect paste is provided with the method of the invention, and an improved method for cooling heated insect puree is provided. In addition, an improved insect paste according to the invention is provided having beneficial water holding capacity (WHC) and/or having improved protein dispersibility index (PDI).

In addition, a cooling assembly 1 (See FIGS. 1-12) is provided for application in the improved method of the invention, such that the improved insect paste of the invention can be produced. With the improved method, insect paste can be provided in relatively short time, while the microbial count of the provided insect paste is still sufficiently low (or even lower) compared to insect paste provided by applying conventional methods. Furthermore, in certain embodiments, by applying the method of the invention, e.g. using the cooling assembly of the invention, the produced insect paste not only loses less water when put under heat stress in the water holding capacity (WHC) test, compared to insect paste obtained using methods commonly applied, but the paste also has an improved protein dispersibility index (PDI), i.e. a higher PDI, when compared to the PDI of insect paste known in the art, and moreover, in some embodiments the insect paste provided with the method of the invention has a more appealing and relatively lighter color than insect paste produced conventionally. Importantly, the insect paste provided with the method of the invention, e.g. by applying the cooling assembly of the invention, has a microbial count comparable to (or lower than) the microbial count determined in insect puree or the like, obtained with methods commonly applied in the art (longer lasting cooling steps (for example, a relatively long waiting time by leaving (a large batch of 100 liter or more of) hot insect puree standing still at ambient temperature or at lower temperature), while the heated insect puree is not flowing and/or while the insect puree is at steady state, without being swirled, shaken, stirred or the like, but just left standing still at a certain temperature such that heat exchange between the puree and the surrounding at lower temperature takes relatively long and is relatively inefficient compared to cooling heated insect puree by applying the method of the invention). Herewith, the method of the invention provides within a short time period an insect paste with a microbial count that makes the paste suitable for consumption as is (e.g. pet feed, fish feed, etc.) or when further processed (oil derived from the paste, paste as an ingredient in a feed product or food stuff, protein meal derived from the paste, etc.). Moreover, in certain embodiments the paste provided with the method of the invention, e.g. by using the cooling assembly of the invention, has improved further specifications, compared to paste obtained with longer lasting insect puree or pulp cooling protocols. That is to say, in embodiments, at least one, preferably two, more preferably three of: an improved lighter color (when compared to paste obtained with conventional cooling), a reduced water loss when heated (expressed as the water holding capacity), and a higher protein dispersibility (expressed as the protein dispersibility index), is/are achieved by applying the method of the invention with heated insect pulp such as heated black soldier fly larvae pulp, such as at 90° C., wherein the larvae are typically 8-18 days of age.

An aspect of the invention relates to an insect paste with a water holding capacity (WHC) of 90% or higher, preferably 90.5% or higher, more preferably 91% or higher, most preferably 92% or higher, such as 92.5% or higher or 93.5% or higher, based on the total weight of the insect paste, preferably in the range of 90% by weight-98% by weight, wherein the WHC is expressed as 100% minus the weight percentage of water that is released from the insect paste during a heating step subjected to the insect paste at a temperature of 121° C. for 80 minutes, based on the total weight of the insect paste before being subjected to this heating step. An embodiment is the insect paste of the invention, wherein the insect paste has a water holding capacity (WHC) in the range 91% by weight-97% by weight, based on the total weight of the insect paste, wherein the WHC is expressed as 100% minus the weight percentage of water that is released from the insect paste during a heating step subjected to the insect paste at a temperature of 121° C. for 80 minutes, based on the total weight of the insect paste before being subjected to this heating step, preferably higher than 92% by weight or 92% by weight-96% by weight, more preferably 92.5% by weight-95.5% by weight, most preferably 93% by weight-95% by weight, such as 94% by weight±2% by weight or 94% by weight±3% by weight.

Furthermore, the insect paste of the invention has a higher protein dispersibility index than seen for insect puree, pulp or paste provided with a conventional method in the art. The inventors were able to provide an insect paste with a PDI of at least 42%. An embodiment is the insect paste of the invention, wherein the insect paste has a protein dispersibility index (PDI) of at least 42% by weight based on the total weight of the insect paste, wherein the protein dispersibility index is determined according to AOCS Standard Procedure Ba 10-09 2017 and wherein, in accordance with the AOCS Standard Procedure Ba 10-09 2017, protein content is determined with the Dumas method in accordance with NEN-EN-ISO 16634, such as a PDI of 42-56% by weight, preferably at least 43% by weight or 43-54% by weight, more preferably at least 44% by weight, or 44-52% by weight, most preferably at least 45% by weight, or 45-50% by weight. The embodiment can be combined with any one or more of the previous embodiments relating to the insect paste of the invention.

Preferably, the insect paste of the invention is provided by applying the method of the invention, and more preferably, by using the cooling assembly of the invention in the method of the invention.

Preferably, the insect paste is produced from heated minced BSF larvae, typically at an age of 9-15 days, such as about 14 days or 10-12 days of age, post hatching.

A further aspect of the invention relates to a method for batch-wise providing insect paste, the method comprising the steps of, or the method consisting of the steps of:
(a) providing heated insect pulp that is at a temperature of 45° C. or higher;
(b) cooling the heated insect pulp of step (a) in a first cooling phase to a temperature of 45° C.-35° C. within a first time period, therewith providing pre-cooled insect pulp; and
(c) cooling the pre-cooled insect pulp of step (b) to a temperature of below 35° C. in a second cooling phase that starts within a second time period starting at the end of the first time period of step (b), and that lasts for a third time period,
   therewith providing the batch of insect paste.

Preferably, the cooling step (c) starts within a second time period after the end of the first time period of step (b), and that lasts for a third time period. More preferably, wherein in the step (c) of the method the second time period starts at 5 seconds-30 minutes, more preferably at 10 seconds-20 minutes, most preferably at 20 seconds-10 minutes, such as 30 seconds-5 minutes or 1 minute-3 minutes. Preferably, the delay between the end of step (b) and the start of step (c) of the method is at least 5 seconds. Preferably, in the method, a first cooling process is applied in the first cooling phase, and a second cooling process is applied in the second cooling phase, wherein the second cooling process is different from the first cooling process.

A further aspect of the invention relates to a method for batch-wise providing insect paste, the method comprising the steps of, or the method consisting of the steps of:
(a) providing heated insect pulp that is at a heated temperature, preferably being 45° C. or higher;
(b) cooling the heated insect pulp of step (a) in a first cooling phase using a first cooling process to a first cooling temperature below the heated temperature within a first time period, preferably said first cooling temperature being in the range 45° C.-35° C., therewith providing pre-cooled insect pulp; and
(c) cooling the pre-cooled insect pulp of step (b) to a second temperature of below the first cooling temperature, preferably below 35° C., in a second cooling phase using a second cooling process that starts within a second time period starting at the end of the first time period of step (b), and that lasts for a third time period,
   therewith providing the batch of insect paste,
   wherein the second cooling process is different from the first cooling process.

Preferred is the method of the invention, wherein in step (a) of the method the provided heated insect pulp is insect pulp obtained by the process steps of:
(i) providing insects, preferably insects that are washed, preferably washed with water;
(ii) preparing a pulp from the insects of process step (i); and
(iii) heating the insect pulp of process step (ii) for 50 seconds-1 hour, preferably for 55 seconds-30 minutes, more preferably 65 seconds-10 minutes, most preferably 70 seconds-5 minutes, at a temperature of 60° C.-100° C., preferably 85° C.-95° C., and optionally subsequently cooling to a temperature of 45° C.-99.5° C., optionally 60° C.-95° C.,
   therewith providing the heated insect pulp of step (a) of the method.

The second cooling process according to said aspect of the invention is different from the first cooling process. Preferably, the first cooling process in the first cooling phase is selected for faster and controllable cooling processing of heated insect pulp, while preventing a solidifying of the cooled insect pulp. Typically, the heated insect pulp is cooled to a temperature at which the insect pulp does not solidify, such as solidification due to solidifying fat in the pulp.

Preferably, the second cooling process in the second cooling phase is selected for a somewhat slower cooling rate compared to the cooling rate induced during the first cooling phase by the first cooling process. More preferably, the second cooling process further comprises an agitating step for stirring or mixing the pre-cooled pulp during the second cooling phase.

It is preferred that during the first cooling phase of step (b) of the method, the heated insect pulp is flowing during the cooling. More preferably, during the first cooling phase of step (b) of the method, the heated insect pulp is flowing while applying a counter current heat exchange process. Thus, said first cooling process is a counter current heat exchange process.

It is preferred that during the second cooling phase of step (c) of the method, the pre-cooled insect pulp is stirred or mixed during the cooling. In an example, the second cooling process provides a heat exchange between an agitated or stirred or mixed pre-cooled insect pulp and a wall of a cooling receptacle, such as a cooling tank, due to a constant movement of the pulp along an inner side of the wall of the cooling receptacle.

In a method of the invention, the heated insect pulp of method step (a) is for example derived from insect larvae, preferably from black soldier fly larvae. The embodiment can be combined with any one or more of the previous embodiments relating to the method.

Typically, in the method of the invention, the heated insect pulp of method step (a) is derived from insect larvae, preferably from black soldier fly larvae, wherein said larvae are between 8 and 30 days of age, preferably between 10 and 28 days, more preferably 12-26 days, most preferably at an age 12 hours-3 days before the larvae transform into prepupae, such as 1-2 days before said transformation, and more preferably, the heated insect pulp of step (a) of the method is derived from black soldier fly larvae that are 10-20 days of age or that are at an age 12 hours-3 days before the black soldier fly larvae transform into prepupae. The embodiment can be combined with any one or more of the previous embodiments relating to the method.

According to the method of the invention, the process step (ii) of the method step (a) can comprise or consist of:
(ii) mincing the insects of process step (i) of the method step (a),
   therewith providing the insect pulp for subsequent process step (iii) of the method step (a). The embodiment can be combined with any one or more of the previous embodiments relating to the method.

Typically, in the method of the invention, the average particle size of remains of the insects in the insect pulp of step (a) of the method is in the range of 10 micrometer-500 micrometer, preferably in the range of 25 micrometer-400 micrometer, more preferably in the range of 40 micrometer-300 micrometer, most preferably in the range of 50 micrometer-250 micrometer. The embodiment can be combined with any one or more of the previous embodiments relating to the method.

Preferred is the method of the invention, wherein in process step (iii) of the method step (a) the insect pulp is heated for 60-360 seconds, preferably at a temperature of 80° C.-98° C., preferably for 75-300 seconds, preferably at a temperature of 85° C.-95° C., more preferably for 77-180 seconds, more preferably at a temperature of 87° C.-93° C., most preferably for 80-160 seconds±2 seconds, most preferably at a temperature of 90° C.±2° C., therewith providing the heated insect pulp of step (a) of the method. The embodiment can be combined with any one or more of the previous embodiments relating to the method.

Typically, in the method of the invention, in process step (iii) of the method step (a) the insect pulp is heated for 70-180 seconds±2 seconds at a temperature of 90° C.±2° C., therewith providing the heated insect pulp of step (a) of the method, in particular when the insect pulp is derived from insect larvae, preferably black soldier fly larvae. Typically, in the method of the invention, in process step (iii) of the method step (a) the insect pulp is heated for 80 seconds±2 seconds at a temperature of 90° C.±2° C., therewith providing the heated insect pulp of step (a) of the method, in particular when the insect pulp is derived from insect larvae, preferably black soldier fly larvae. Preferably, in the method of the invention, in process step (iii) of the method step (a) the insect pulp is heated for 70-180 seconds±2 seconds at a temperature of 90° C.±2° C., therewith providing the heated insect pulp of step (a) of the method, when the insect pulp is derived from insect larvae, preferably black soldier fly larvae. Preferably, in the method of the invention, in process step (iii) of the method step (a) the insect pulp is heated for 80 seconds±2 seconds at a temperature of 90° C.±2° C., therewith providing the heated insect pulp of step (a) of the method, when the insect pulp is derived from insect larvae, preferably black soldier fly larvae. The embodiment can be combined with any one or more of the previous embodiments relating to the method.

For example, in the method of the invention, the heated insect pulp provided in method step (a) is at a temperature of 45° C.-100° C., optionally 50° C.-97° C., 55° C.-95° C., or 60° C.-93° C. The embodiment can be combined with any one or more of the previous embodiments relating to the method.

For example, in the method of the invention, the heated insect pulp provided in method step (a) is at a temperature of 65° C.-98° C., optionally 75° C.-95° C., 85° C.-93° C., or 90° C.±2° C. The embodiment can be combined with any one or more of the previous embodiments relating to the method.

For example, in the method of the invention, in the first cooling phase of step (b) of the method the heated insect pulp is cooled to a temperature of 45° C.-36° C., preferably to 43° C.-38° C. The embodiment can be combined with any one or more of the previous embodiments relating to the method.

It is part of the invention that typically in the first cooling phase of step (b) of the method the first time period is 2 seconds-30 minutes, preferably 5 seconds-20 minutes, more preferably 10 seconds-10 minutes, most preferably 30 seconds-5 minutes, such as 1 minute-4 minutes, till the pre-cooled insect pulp is provided. The embodiment can be combined with any one or more of the previous embodiments relating to the method.

Preferred is the method of the invention, wherein in the step (c) of the method the second time period starts at 0 seconds-45 minutes (that is to say, after a waiting time of, here, 0 seconds-45 minutes) since the end of the first time period of step (b) of the method, preferably at 5 seconds-30 minutes, more preferably at 10 seconds-20 minutes, most preferably at 20 seconds-10 minutes, such as 30 seconds-5 minutes or 1 minute-3 minutes. Preferably, the delay between the end of step (b) and the start of step (c) of the method is about 0 seconds. For example, when the first cooling phase is conducted by applying the first cooling process (method), and the second cooling phase is conducted by applying the second cooling process (method), which is different from the first cooling process, transfer of the insect pulp from a processing unit, such as a container, for applying the first cooling phase, in which the first cooling process is conducted with the insect pulp, to a container for applying the second cooling phase, in which the second cooling process is conducted with the insect pulp, is required. Said transfer of insect pulp ideally is instantaneously. That is to say, the insect pulp is transferred from the container for applying the first cooling phase directly into the container for applying the second cooling phase, which two containers are in fluid connection such that no waiting time is present between the end of the first cooling phase and the start of the second cooling phase. It is equally preferred when a waiting time is applied between the end of the first cooling phase and the start of the second cooling phase, which waiting time is the time for transferring the insect pulp from the container for applying the first cooling phase into the container for applying the second cooling phase, for example through a pipe fluidly connecting the container for applying the first cooling phase and the container for applying the second cooling phase. The embodiment can be combined with any one or more of the previous embodiments relating to the method.

An embodiment is the method of the invention, wherein in the step (c) of the method the third time period is 10 minutes-6 hours, preferably 20 minutes-5 hours, more preferably 30 minutes-4 hours, most preferably 40 minutes-3 hours, such as 50 minutes-2.5 hours or 1 hour-2 hours. The embodiment can be combined with any one or more of the previous embodiments relating to the method. Typically, the step (c) lasts for about one-three hour(s), preferably one-two hour(s), to provide insect paste from pre-cooled insect pulp. The embodiment can be combined with any one or more of the previous embodiments relating to the method.

For reducing or avoiding microbial growth, the insect paste is typically kept at 3° C.-6° C. when provided with step (c) of the method. Therefore, in the method of the invention, in the step (c) of the method the pre-cooled insect pulp of step (b) is for example cooled to a temperature of 12° C.-0° C., preferably 10° C.-2° C., more preferably 8° C.-3° C., most preferably 7° C.-4° C., such as 9° C.-1° C. or 7° C.-3° C. Preferably 3° C.-6° C. The embodiment can be combined with any one or more of the previous embodiments relating to the method.

For increasing shelf life, the insect paste provided with the method of the invention can be further cooled during method step (c) or after method step (c) in a method step (d): further cooling of the insect paste to a temperature lower than 0° C. Thus, it is part of the invention that in the method, in the step (c) of the method the pre-cooled insect pulp of step (b) is cooled to a temperature of 0° C.-−83° C., preferably −4° C.-−63° C., more preferably −8° C.-−43° C., most preferably −10° C.-−23° C., such as −1° C.-−30° C. or −2° C.-−15° C., therewith providing the insect paste, or the insect pulp is further cooled in a subsequent step (d) of the method, to a temperature of 0° C.-−83° C., preferably −4° C.-−63° C., more preferably −8° C.-−43° C., most preferably −10° C.-−23° C., such as −1° C.-−30° C. or −2° C.-−15° C., therewith providing the insect paste. The embodiment can be combined with any one or more of the previous embodiments relating to the method.

The method of the invention provides a fast way of providing insect past at low temperature (e.g. 7° C. or lower) from heated insect pulp at a temperature of e.g. 90° C., such that the temperature window in which the risk for microbial growth is most apparent (i.e. temperature above 10° C.), has a relatively short duration (typically 30 minutes-1 hour, typically about 1 hour). One way of establishing the fast cooling to a temperature lower than 10° C. is by applying the cooling assembly 1 (see FIG. 1-12, in particular FIG. 7) in the method of the invention, which cooling assembly is also part of the invention. An embodiment is the method of the invention, wherein in the method step (b) the cooling of the heated insect pulp is cooling by applying counter current heat exchange, wherein the heated insect pulp flows through an inner pipe 8, 8a, which is held concentrically inside an outer pipe 9, 9a, in a first direction and wherein a cooling medium c1 such as a liquid such as water flows through the outer pipe along the concentrically held inner pipe in a second direction opposite to the first direction, or wherein the cooling liquid such as water flows through said inner pipe in the first direction and wherein the heated insect pulp flows through the outer pipe along the concentrically held inner pipe in said second direction. Preferably, the cooling assembly 1 is applied in the method of the invention, which comprises such features for counter current heat exchange (see for example FIG. 7). The embodiment can be combined with any one or more of the previous embodiments relating to the method.

For example, in the method of the invention, in the method step (c) the cooling of the pre-cooled insect pulp is cooling using a double-jacketed tank 19, 20 (see FIGS. 1-7, 12) containing the pre-cooled insect pulp L2, wherein the pre-cooled insect pulp is agitated, stirred or mixed in the tank 19, while a cooling liquid c2 such as water or a water:glycol mixture, is flowing through the double jacket 20 that at least partly encompasses the tank 19, or wherein in the method step (c) the cooling of the pre-cooled insect pulp is cooling using a tank 19a comprising a coiled tube 23 in the inner volume of the tank, the tank containing the pre-cooled insect pulp L2 such that the pre-cooled insect pulp contacts at least part of the coiled tube, wherein the pre-cooled insect pulp is optionally agitated, stirred or mixed in the tank, while a cooling liquid c2 such as a water:glycol mixture, is flowing through the coiled tube 23. Typically, this cooling is performed by applying the cooling assembly 1 according to the invention. Preferred is the double-jacket tank. Reference is for example made to FIG. 1-7, 10-12. The embodiment can be combined with any one or more of the previous embodiments relating to the method.

The method of the invention is suitable for relatively fast provision of relatively small-scale cooled insect paste, as well as for relatively fast provision of relatively large-scale cooled insect paste, at e.g. 1 liter-5.000 liter scale. Therefore, it is part of the invention that the method provides a batch of insect paste consisting of 8 liter-20.000 liter insect paste, preferably 16 liter-10.000 liter, more preferably 32 liter-5.000 liter, most preferably 64 liter-2.500 liter. The scale and size of for example the counter-current heat exchanger applied in step (b) of the method and/or for example the volume of the cooling tank 14 (FIG. 1-7) are adapted to the mass or volume of insect paste batches that are desired. Since the time required to provide insect paste with the method of the invention is relatively short (e.g. less than 70 minutes such as less than 40 minutes; about 3 minutes for step (b), about half an hour to 1 hour for step (c) of the method), scaling up the volume of each batch of heated insect pulp provided in step (a) of the method provides for a highly flexible method of providing insect paste in a relatively short time frame, wherein the insect paste has improved specifications. The embodiment can be combined with any one or more of the previous embodiments relating to the method.

An embodiment is the method of the invention, wherein the method provides a batch of insect paste consisting of between 64 liter-2.500 liter insect paste, preferably consisting of 128 liter-1.250 liter, more preferably 200 liter-800 liter, most preferably 300 liter-600 liter. The embodiment can be combined with any one or more of the previous embodiments relating to the method.

Similarly, an embodiment is the method of the invention, wherein the method provides a batch of insect paste consisting of 10 kg-20.000 kg insect paste, preferably 20 kg-10.000 kg, more preferably 40 kg-5.000 kg, most preferably 80 kg-2.500 kg. Preferred is the method of the invention, wherein the method provides a batch of insect paste consisting of between 80 kg-2.500 kg insect paste, preferably consisting of 120 kg-1.250 kg, more preferably 200 kg-800 kg, most preferably 300 kg-600 kg. The embodiment can be combined with any one or more of the previous embodiments relating to the method.

The method of the invention is suitable for providing insect paste such as paste from minced black soldier fly larvae that were 10-14 days of age post hatching, in undiluted form. That is to say, the insect paste provided with the method preferably consists of minced insects only, without diluting the heated insect pulp that is provided in step (a) of the method, without diluting the pre-cooled insect pulp provided with step (b) of the method, and without diluting the insect paste during step (c) of the method, or at the end of step (c).

Alternatively, the method of the invention is also suitable for providing diluted insect paste. In step (a) of the method, diluted heated insect pulp can be provided; in step (b), during the step or at the end or at the start, heated insect pulp or pre-cooled insect pulp can be diluted, e.g. with water, a buffer, a physiological salt solution, an oil such as a vegetable oil, etc.; at the start of step (c), during step (c) or at the end of step (c) the pulp or paste can be diluted similarly. Therefore, it is part of the invention that in any one or more of method step (a), method step (b) and method step (c) a diluent, such as water or an oil, is mixed with the pulp or the paste, such that the heated insect pulp provided in method step (a) and/or the pre-cooled insect pulp provided in method step (b) and/or the insect paste provided in method step (c) comprises 0%-95% by weight of the diluent, based on the total weight of the heated insect pulp, the pre-cooled insect pulp and/or the insect paste, such as 5%-80% by weight, 10%-70% by weight, 20%-60% by weight, or 30%-50% by weight. Basically, the method of the invention is applicable for providing insect paste at any degree of dilution. The embodiment can be combined with any one or more of the previous embodiments relating to the method.

The insect paste according to the invention is preferably minced, and/or is preferably non-fractioned. Non-fractioned is defined herein as using or processing an insect paste of the insects or minced insects substantially without separating or removing a fraction, such as an oil or a fat or water (moisture), from said (minced) insects. The purpose of the non-fractioned insect paste is to provide substantially the whole insects in a beneficial form.

The method of the invention is applicable in combination with a means suitable for fast cooling of the puree-like semi-solid heated insect pulp provided in step (a) of the method, in step (b) of the method, e.g. 1 liter-1.000 liter pulp at e.g. 90° C.±3° C., to a temperature of e.g. 35° C.-45° C. within several minutes to several tens of minutes (e.g. 10-40 minutes), such as 2 minutes-8 minutes, e.g. 3 minutes±1 minute, and in combination with a means suitable for further fast cooling of said for example 1 liter-1.000 liter pre-cooled insect pulp provided with step (b), to a temperature of below 10° C., such as 2°-8° C. or 3° C.-7° C., within a few hours such as within 2 hours, 90 minutes, 1 hour, 45 minutes, 30 minutes, 25 minutes, 20 minutes. The cooling assembly 1 of the invention (FIGS. 1-12) provides for such a means, both for step (a) and step (b) and step (c) of the method of the invention, in particular for step (b) and (c). The embodiment can be combined with any one or more of the previous embodiments relating to the method.

An aspect of the invention relates to a cooling assembly 1 for batch-wise provision of insect paste, comprising:
a first container 2 for containing heated insect pulp L1; the first container being in fluid connection with the upstream end 4 of a first pipe p1; the first pipe optionally comprising a first driver d1 such as a pump;
the first driver being configured for driving heated insect pulp L1 through the first pipe p1 towards the downstream end 5 of the first pipe;
the downstream end 5 of the first pipe p1 being in fluid connection with the upstream end 6 of an inner pipe 8 of a first cooling unit 7; wherein
the first cooling unit 7 is arranged for counter current heat exchange and comprises the inner pipe 8 which is held concentrically inside an outer pipe 9 of the first cooling unit 7; wherein the outer pipe 9 is in fluid connection with a source 10 of a first cooling medium c1 and a second driver d2; the second driver d2 being configured for flowing the first cooling medium c1 through the outer pipe 9 in opposite direction to heated insect pulp L1 flowing through the inner pipe 8 of the first cooling unit 7, wherein
the downstream end 11 of the inner pipe 8 of the first cooling unit 7 is in fluid connection with the upstream end 12 of a second pipe p2; the second pipe p2 optionally comprising a third driver d3 such as a pump; the third driver d3 being configured for driving pre-cooled insect pulp L2 exiting from the first cooling unit 7 through the second pipe p2 towards the downstream end 13 of the second pipe p2; wherein
the downstream end 13 of the second pipe p2 ends in a first cooling receptacle 14, 14a, and preferably the downstream end 13 of the second pipe p2 is in fluid connection with a first inlet 15 of the first cooling receptacle 14, 14a; wherein
the first cooling receptacle 14, 14a is provided with a first means 16 for further cooling pre-cooled insect pulp L2 when present in the first cooling receptacle 14, 14a, and with a means 18 for agitating such as a rotor with blades 18, a mixer 18, a stirrer 18; wherein
the first cooling receptacle 14, 14a is provided with a first outlet 17 configured for discharging insect paste from the first cooling receptacle 14, 14a; and
wherein the cooling assembly 1 comprises at least one of the first driver d1 and the third driver d3. See also FIG. 1, 8-12.

The first pipe p has an upstream end 4 and an downstream end 5. The inner pipe 8 of a first cooling unit 7 has an upstream end 6 and an downstream end 11. The second pipe p2 has an upstream end 12 and an downstream end 13.

An embodiment is the cooling assembly 1 according to the invention, wherein the first means 16 for further cooling being a tank 19 comprising a double jacket 20 configured for flowing a second cooling medium c2 through the double jacket 20 and in fluid connection with a source of second cooling medium via a tube 22 provided with a driver d, such that insect paste L3 can be produced by cooling pre-cooled insect pulp L2 contained in the first cooling receptacle 14, 14a when the cooling assembly 1 is in operation. See also FIGS. 1-7, 11 and 12.

Alternatively or additively, also part of the invention is the cooling assembly 1 according to the invention, wherein the first means 16a for further cooling being a tank 19a comprising a spiral tube 23 in the inner volume of the tank 19a and configured for flowing a second cooling medium c2 through the spiral tube 23 and in fluid connection with a source 21 of the second cooling medium c2 via a tube 22 provided with a driver d, such that insect paste can be produced by cooling pre-cooled insect pulp L2 contained in the first cooling receptacle 14, 14a when the cooling assembly 1 is in operation. See also FIGS. 1 and 10.

An embodiment is the cooling assembly 1 according to the invention, wherein the first container 2 is in fluid connection with a second container 24 configured to contain heated insect pulp, wherein the second container 24 is optionally configured to heat insect pulp, and wherein the second container 24 is configured to fill the first container 2 with heated insect pulp. The embodiment can be combined with any one or more of the previous embodiments relating to the cooling assembly 1. See also FIG. 2.

An embodiment is the cooling assembly 1 according to the invention, wherein the cooling assembly 1 comprises a second cooling unit 7a, wherein the downstream end 11 of the inner pipe 8 of the first cooling unit 7 is in fluid connection with the upstream end 25 of an inner pipe 8a of the second cooling unit 7a, and wherein the downstream end 26 of the inner pipe 8a of the second cooling unit 7a is in fluid connection with the upstream end 12 of the second pipe p2,
wherein the second cooling unit 7a is arranged for counter current heat exchange, wherein the inner pipe 8a of the second cooling unit 7a is held concentrically inside an outer pipe 9a of the second cooling unit 7a; wherein the outer pipe 9a of the second cooling unit 7a is in fluid connection with the outer pipe 9 of the first cooling unit 7, the source 10 and the second driver d2; the second driver d2 being further configured for flowing the first cooling medium c1 through the outer pipe 9a of the second cooling unit 7a in opposite direction to insect pulp flowing through the inner pipe 8a of the second cooling unit 7a. The embodiment can be combined with any one or more of the previous embodiments relating to the cooling assembly 1. See also FIGS. 3 and 7-9.

An embodiment is the cooling assembly 1 according to the invention, wherein the second pipe p2 is in fluid connection with the upstream end 27 of a branching third pipe p3 that is provided with a valve v6;
a downstream end 28 of the third pipe p3 being in fluid connection with the first container 2;
the third pipe p3 optionally comprising a fifth driver d5 configured for driving pre-cooled insect pulp from the second pipe p2 to the first container 2. The embodiment can be combined with any one or more of the previous embodiments relating to the cooling assembly 1. See also FIGS. 4 and 7.

An embodiment is the cooling assembly 1 according to the invention, wherein the downstream end 13 of the second pipe p2 branches into at least a fourth pipe p4 and a fifth pipe p5; the fourth pipe p4 ending in the first cooling receptacle 14; and preferably the downstream end 13 of the second pipe p2 is in fluid connection with the fourth pipe p4 which is in fluid connection with the first inlet 15 of the first cooling receptacle 14;
the fourth pipe p4 being provided with a valve v2;
the fifth pipe p5 ending in a second cooling receptacle 14a, and preferably the downstream end 13 of the second pipe p2 is in fluid connection with the fifth pipe p5 which is in fluid connection with a second inlet 29 of the second cooling receptacle;
the fifth pipe p5 being provided with a valve v7; wherein
the second cooling receptacle 14a is provided with a second means 16, 16a for further cooling pre-cooled insect pulp when present in the second cooling receptacle 14a, and with a means 18, 18a for agitating such as a rotor with blades 18, 18a, a mixer 18, 18a, a stirrer 18, 18a; wherein
the second cooling receptacle 14a is provided with a second outlet 17a configured for discharging insect paste from the second cooling receptacle 14a. The embodiment can be combined with any one or more of the previous embodiments relating to the cooling assembly 1. See also FIGS. 5 and 7.

An embodiment is the cooling assembly 1 according to the invention, wherein the first outlet 17 of the first cooling receptacle 14 is in fluid connection with a sixth pipe p6 that is provided with a valve v3, and, if present, a second outlet 17a of the second cooling receptacle 14a is in fluid connection with a seventh pipe p7 that is provided with a valve v8, wherein optionally the sixth pipe p6 and/or the seventh pipe are provided with a driver d6, d10 configured to drive insect paste from the cooling receptacle(s) 14, 14a through the sixth and/or seventh pipe p6, p7. The embodiment can be combined with any one or more of the previous embodiments relating to the cooling assembly 1. See also FIGS. 6 and 7.

An embodiment is the cooling assembly 1 according to the invention, wherein the first outlet 17 of the first cooling receptacle 14 is in fluid connection with the upstream end 17′ of a sixth pipe p6 that is provided with a valve v3, and, if present, a second outlet 17a of the second cooling receptacle 14a is in fluid connection with the upstream end 17a′ of a seventh pipe p7 that is provided with a valve v8, wherein, if the second outlet is present, the downstream end 17″ of the sixth pipe and the downstream end 17a″ of the seventh pipe are in fluid connection with the upstream end 3 of an eighth pipe p8, wherein optionally the eighth pipe p8 is provided with a driver d10 configured to drive insect paste from the first cooling receptacle 14 and through the sixth pipe p6 and, if present, from the second cooling receptacle 14a and through the seventh pipe p7, and subsequently through the eighth pipe p8. The embodiment can be combined with any one or more of the previous embodiments relating to the cooling assembly 1. See also FIG. 7.

An embodiment is the cooling assembly 1 according to the invention, wherein the cooling assembly 1 further comprises
a third container 30 for containing insect paste, that is in fluid connection with the first outlet 17 of the first cooling receptacle 14, and the second outlet 17a of the second cooling receptacle 14a when present, with the sixth pipe p6 and the seventh pipe p7 when present, and with the eighth pipe p8 when present. The embodiment can be combined with any one or more of the previous embodiments relating to the cooling assembly 1. See also FIGS. 6 and 7.

An embodiment is the cooling assembly 1 according to the invention, wherein the first container 2, and/or the first pipe p1, the first cooling unit 7 and, if present, the at least one second cooling unit 7a and the second pipe p2, and/or the first cooling receptacle 14, 14b or the second cooling receptacle 14a, 14b, and/or the third container 30 has/have a capacity of containing a volume of at least 8 liter, such as 8 liter-20.000 liter, preferably 16 liter-10.000 liter, more preferably 32 liter-5.000 liter, most preferably 64 liter-2.500 liter. The embodiment can be combined with any one or more of the previous embodiments relating to the cooling assembly 1. See also FIG. 1-7.

An embodiment is the cooling assembly 1 according to the invention, wherein the first container 2, and/or the first pipe p1, the one or more of the first cooling unit 7 and, if present, at least one second cooling unit 7a and the second pipe p2, and/or the first cooling receptacle 14, 14b or the second cooling receptacle 14a, 14b, and/or the third container 30 has/have a capacity of containing a volume of at least 64 liter, such as between 64 liter-2.500 liter, preferably a capacity of 128 liter-1.250 liter, more preferably 200 liter-800 liter, most preferably 300 liter-600 liter. The embodiment can be combined with any one or more of the previous embodiments relating to the cooling assembly 1. See also FIG. 1-7.

An embodiment is the cooling assembly 1 according to the invention, wherein the first container 2, and/or the first pipe p1, the one or more of the first cooling unit 7 and, if present, at least one second cooling unit 7a and the second pipe p2, and/or the first cooling receptacle 14, 14b or the second cooling receptacle 14a, 14b, and/or the third container 30 has/have a capacity of containing a mass of at least 10 kg, such as 10 kg-20.000 kg, preferably 20 kg-10.000 kg, more preferably 40 kg-5.000 kg, most preferably 80 kg-2.500 kg. The embodiment can be combined with any one or more of the previous embodiments relating to the cooling assembly 1. See also FIG. 1-7.

An embodiment is the cooling assembly 1 according to the invention, wherein the first container 2, and/or the first pipe p1, the one or more of the first cooling unit 7 and, if present, at least one second cooling unit 7a and the second pipe p2, and/or the first cooling receptacle 14, 14b or the second cooling receptacle 14a, 14b, and/or the third container 30 has/have a capacity of containing a mass of at least 80 kg, such as a capacity of between 80 kg-2.500 kg, preferably a capacity of 120 kg-1.250 kg, more preferably 200 kg-800 kg, most preferably 300 kg-600 kg. The embodiment can be combined with any one or more of the previous embodiments relating to the cooling assembly 1. See also FIG. 1-7.

An embodiment is the cooling assembly 1 according to the invention, wherein the source 10 of the first cooling medium c1 is a tap water work 10. The embodiment can be combined with any one or more of the previous embodiments relating to the cooling assembly 1. See also FIG. 1-7.

An embodiment is the cooling assembly 1 according to the invention, wherein the means 16, 16a for cooling pre-cooled insect pulp L2 if present in the first cooling receptacle 14 and/or in the second cooling receptacle 14a, when the second cooling receptacle 14a is present, further is provided with a chilling unit 21′ configured to chill the second cooling medium c2 before being driven to the double jacket 20 or the spiral tube 23 of the first cooling receptacle 14 and/or the second cooling receptacle 14a. The embodiment can be combined with any one or more of the previous embodiments relating to the cooling assembly 1. See also FIGS. 1-4 and 7.

An embodiment is the cooling assembly 1 according to the invention, wherein the means 16, 16a for cooling pre-cooled insect pulp L2 if present in the first cooling receptacle 14 and/or in the second cooling receptacle 14a, when the second cooling receptacle 14a is present, is configured as a closed circuit 31 for circulating the second cooling medium c2. The embodiment can be combined with any one or more of the previous embodiments relating to the cooling assembly 1. See also FIG. 1-7.

Preferred is the method of the invention, wherein the method is applied by using the cooling assembly 1 of the invention, in particular the cooling assembly 1 as outlined in any one of the FIGS. 1-7, more in particular the cooling assembly 1 of FIG. 7. The cooling assembly 1 of the invention is suitable for rapid pre-cooling step (b) of the method and for rapid cooling step (c) of the method. Therefore, an embodiment is the method of the invention, wherein method step (b) and/or method step (c) is/are performed using the cooling assembly 1 of the invention, preferably both method step (b) and method step (c) are performed using the cooling assembly 1 of the invention. The embodiment can be combined with any one or more of the previous embodiments relating to the method of the invention and/or the embodiment can be combined with any one or more of the previous embodiments relating to the cooling assembly 1 of the invention, in particular the embodiment relating to the cooling assembly 1 of FIG. 7. See also FIG. 1-12.

As said, the method of the invention, e.g. by applying the cooling assembly 1 of the invention, provides insect paste at cool temperature in a short time from heated insect pulp up to (large scale) batches of insect pulp at a temperature below 10° C. The relatively fast cooling time provides for insect paste with a microbial count that is similar or lower than the microbial count determined in insect puree obtained by applying cooling protocols that last longer (e.g. up to 12 hours or more to cool heated insect puree at about 90° C. to a temperature below 10° C.). Arriving at low temperature in a shorter time span, such that the puree, pulp or paste is only for a relatively short time at a temperature at which microbial growth is most likely to occur, is beneficial for provision of insect pulp with low(er) microbial count. Furthermore, the relatively fast cooling provides insect paste which presents with a relatively low water loss when heated up to 121° C. for 80 minutes. This application of heat stress of heating for 80 minutes at 121° C. in a closed container, is a condition that simulates the condition of canning process of pet food known in the art.

As mentioned above, one aspect of the invention relates to an insect paste with a water holding capacity (WHC) of 90% or higher, preferably 90.5% or higher, more preferably 91% or higher, most preferably 92% or higher, such as 92.5% or higher or 93.5% or higher, based on the total weight of the insect paste, preferably in the range of 90% by weight-98% by weight, wherein the WHC is expressed as 100% minus the weight percentage of water that is released from the insect paste during a heating step subjected to the insect paste at a temperature of 121° C. for 80 minutes, based on the total weight of the insect paste before being subjected to this heating step. An embodiment is the insect paste of the invention, wherein the insect paste has a water holding capacity (WHC) in the range 91% by weight-97% by weight, based on the total weight of the insect paste, wherein the WHC is expressed as 100% minus the weight percentage of water that is released from the insect paste during a heating step subjected to the insect paste at a temperature of 121° C. for 80 minutes, based on the total weight of the insect paste before being subjected to this heating step, preferably higher than 92% by weight or 92% by weight-96% by weight, more preferably 92.5% by weight-95.5% by weight, most preferably 93% by weight-95% by weight, such as 94% by weight±2% by weight or 94% by weight±3% by weight.

Furthermore, the insect paste of the invention has a higher protein dispersibility index than seen for insect puree, pulp or paste provided with a conventional method in the art. The inventors were able to provide an insect paste with a PDI of at least 42%. An embodiment is the insect paste of the invention, wherein the insect paste has a protein dispersibility index (PDI) of at least 42% by weight based on the total weight of the insect paste, wherein the protein dispersibility index is determined according to AOCS Standard Procedure Ba 10-09 2017 and wherein, in accordance with the AOCS Standard Procedure Ba 10-09 2017, protein content is determined with the Dumas method in accordance with NEN-EN-ISO 16634, such as a PDI of 42-56% by weight, preferably at least 43% by weight or 43-54% by weight, more preferably at least 44% by weight, or 44-52% by weight, most preferably at least 45% by weight, or 45-50% by weight. The embodiment can be combined with any one or more of the previous embodiments relating to the insect paste of the invention. Typically, the insect paste of the invention is provided by applying the method of the invention, and typically, by using the cooling assembly of the invention in the method of the invention. Preferably, the insect paste is produced from heated minced BSF larvae, typically at an age of 9-15 days, such as about 14 days or 10-12 days of age, post hatching.

Preferred is the insect paste of the invention, wherein at least 55% surface area of the insect paste has a color pattern comprising any one or more of hexadecimal color codes (Hex triplets) selected from the range of Hex triplets encompassed by thirteen color code areas that are each defined by at least a single color code and a set of four color code limits and straight lines between these color code limits, in the order top-left to top-right to bottom-right to bottom-left to top-left (single color code(s) in each defined color code area in brackets):
#d6bcb4-#dba697-#875546-#73554d (#ba978d);
#a68f88-#ad8072-#704b40-#6b5c58 (#82635a);
#ad8d84-#b58274-#6e4d44-#755b54 (#6e4d44);
#ccb7b1-#cfa69b-#8f655a-#856d67 (#bfa49d);
#c7a69f-#c78d81-#734a41-#6e5651 (#8c6a63);
#a6887c-#a3664e-#754836-#76574b (#6e5046);
#d9ad9c-#d47b59-#6b4333-#705d55 (#76574b);
#b5988d-#b88672-#7d5748-#8a6c60 (#906f62);
#c7a497-#c28772-#85503d-#966f61 (#966f61);
#c9afab-#d69992-#b69692-#82716f (#876560, #a78a85, #b69692, #bd9d99, #c9a9a3, #bc9c96);
#d6a987-#db9158-#945525-#8a674c (#a8744c);
#c2a491-#c47e52-#8a512d-#876f60 (#a98670); and
#d6a476-#c9803e-#855122-#946c48 (#ae7038),
   preferably at least 58%, more preferably at least 63%, most preferably at least 70%, such as 56-93%, 57-88% or 59-85%. The embodiment can be combined with any one or more of the previous embodiments relating to the insect paste of the invention. Typically, the insect paste of the invention is provided by applying the method of the invention, and typically, by using the cooling assembly of the invention in the method of the invention. Preferably, the insect paste is produced from heated minced BSF larvae, typically at an age of 9-15 days, such as about 14 days or 10-12 days of age, post hatching.

Also preferred is the insect paste of the invention, wherein at least 70% surface area of the insect paste has a color pattern comprising any one or more of hexadecimal color codes (Hex triplets) selected from the range of Hex triplets encompassed by thirteen color code areas that are each defined by at least a single color code and a set of four color code limits and straight lines between these color code limits, in the order top-left to top-right to bottom-right to bottom-left to top-left (single color code(s) in each defined color code area in brackets):
#d6bcb4-#dba697-#875546-#73554d (#ba978d);
#a68f88-#ad8072-#704b40-#6b5c58 (#82635a);
#ad8d84-#b58274-#6e4d44-#755b54 (#6e4d44);
#ccb7b1-#cfa69b-#8f655a-#856d67 (#bfa49d);
#c7a69f-#c78d81-#734a41-#6e5651 (#8c6a63);
#a6887c-#a3664e-#754836-#76574b (#6e5046);
#d9ad9c-#d47b59-#6b4333-#705d55 (#76574b);
#b5988d-#b88672-#7d5748-#8a6c60 (#906f62);
#c7a497-#c28772-#85503d-#966f61 (#966f61);
#c9afab-#d69992-#b69692-#82716f (#876560, #a78a85, #b69692, #bd9d99, #c9a9a3, #bc9c96);
#d6a987-#db9158-#945525-#8a674c (#a8744c);
#c2a491-#c47e52-#8a512d-#876f60 (#a98670); and
#d6a476-#c9803e-#855122-#946c48 (#ae7038),
   preferably at least 72%, more preferably at least 75%, most preferably at least 80%, such as 70-93%, 73-88% or 77-85%. The embodiment can be combined with any one or more of the previous embodiments relating to the insect paste of the invention. Typically, the insect paste of the invention is provided by applying the method of the invention, and typically, by using the cooling assembly of the invention in the method of the invention. Preferably, the insect paste is produced from heated minced BSF larvae, typically at an age of 9-15 days, such as about 14 days or 10-12 days of age, post hatching.

Thus, an embodiment is the insect paste of the invention, obtained with the method according to any one of the previous embodiments relating to the method of the invention, in so far the method comprises in step (a) the process steps (i)-(iii), or an embodiment is the insect paste of the invention, obtainable by the method according to the invention in so far the method comprises in step (a) the process steps (i)-(iii). That is to say, part of the invention is the insect paste obtainable with the method of the invention or the insect paste obtained with the method of the invention, wherein in process step (iii) of step (a) of the method, the insect pulp of process step (ii) is heated for 10 minutes or less, preferably for 8 minutes or less, more preferably for 6 minutes or less, most preferably for 5 minutes or less, such as 70 seconds-10 minutes, 70 seconds-5 minutes or 75 seconds-200 seconds, at a temperature of 80° C.-100° C., preferably 85° C.-95° C., more preferably 90° C.±3° C., most preferably 90° C.±2° C., therewith providing the heated insect pulp of step (a) of the method. The embodiments can be combined with any one or more of the previous embodiments relating to the insect paste of the invention. Typically, the insect paste of the invention is provided by applying the method of the invention, and typically, by using the cooling assembly of the invention in the method of the invention. Preferably, the insect paste is produced from heated minced BSF larvae, typically at an age of 9-15 days, such as about 14 days or 10-12 days of age, post hatching.

An embodiment is the insect paste of the invention, wherein the insect is black soldier fly larvae, wherein preferably said larvae are 6 days-30 days of age, preferably 8 days-28 days of age, more preferably 9-26 days of age, most preferably 10-24 days of age, and/or wherein preferably said larvae are at an age 12 hours-3 days before the larvae transform into prepupae, such as 1-2 days before said transformation, and more preferably, the insect paste is derived from black soldier fly larvae that are 6-20 days of age or that are at an age 12 hours-3 days before the black soldier fly larvae transform into prepupae.

An aspect of the invention relates to any one of a food product, food ingredient, feed product or feed ingredient comprising the insect paste of the invention or comprising the insect paste obtained with the method according to the invention. Typically, the insect paste of the invention is provided by applying the method of the invention, and typically, by using the cooling assembly of the invention in the method of the invention. Preferably, the insect paste is produced from heated minced BSF larvae, typically at an age of 9-15 days, such as about 14 days or 10-12 days of age, post hatching.

### Definitions

The term “insects” as used herein refers to insects in any development stage, such as adult insects, insect larvae, insect prepupae and pupae.

The term “fresh insects” as used herein has its conventional meaning and refers to living insects or insects that have been killed shortly before being provided in step a) of the method of the invention, such as killed within 1 minute-3 hours before being subjected to step a). Fresh insects for example differ from stored insects that have been killed at a certain moment and stored at for example room temperature, 0° C.-8° C. or at a temperature below 0° C. for over 3 hours such as for days to weeks to months to years, before such stored insects are processed. Typically, fresh insects are living black soldier fly larvae.

The term “hatching” as used herein has its conventional meaning and refers to the process of young larvae emerging from the egg.

The term “larvae” as used herein has its conventional meaning and refers to the juvenile stadium of holometabolous insects, such as black soldier flies larvae.

The term “hatchling” or “neonate” as used herein has its conventional meaning and refers to larvae that have just hatched from the eggs.

The term “prepupae” as used herein refers to the last larval stage wherein the chitin content of the larvae has increased significantly.

The term “pupae” as used herein has its conventional meaning and refers to the stage of the insects life wherein the metamorphosis from larva to adult insect, such as black soldier flies.

The term “pulp” or “insect pulp” or “puree” or “larvae puree” or “insect puree” as used herein all have the same meaning and refers to the product obtained after mechanical size reduction of the insects to a size of less than 0.5 mm.

The term “nutrient stream” as used herein has its conventional meaning and refers to streams that contain nutrients, such as fats, protein and protein-derived material, carbohydrates, minerals and/or chitin. Within the context of the present invention, chitin is also considered a nutrient. Within the context of the present invention, the insect puree or insect pulp obtained with the method of the invention is also considered a nutrient.

With the term “drying” or “dried” in the context of the invention, it is meant that the product obtained upon the drying and the dried product have a moisture content that is 20% or less based on the total weight of the product obtained upon the drying or the dried product, preferably 15% or less, more preferably 10% or less, most preferably 5% or less, such as 0.5%-20%, 1%-18%, 2%-16%, 3%-14%, 4%-12% or 6%-8%. Typically, the product that is dried, e.g. the insect pulp, the aqueous protein fraction, the combination of the solid containing fraction and the aqueous protein fraction, has a moisture content before drying of at least 20% based on the total weight of the product before drying, such as at least 25%, at least 30%, at least 40% or at least 45%.

The term “microbial count” has its normal scientific meaning and here refers to the result of the determination of the presence and amount of Enterobacteriaceae in a sample, expressed in cfu/g (cfu: colony forming units), such as in an insect pulp sample or in an insect paste sample, as determined with a method according to NEN-ISO 21528-2, and to the result of the determination of an aerobic mesophilic (plate) count performed in compliance with NEN-ISO 21528-2. In the context of the present invention, the term ‘sufficiently low microbial count’ has its normal scientific meaning and here refers to an amount of less than 10 cfu/g Enterobacteriaceae in a sample and to an aerobic mesophilic plate count of less than 20×10E6 in the sample, preferably less than 10×10E6, more preferably less than 5×10E6, most preferably less than 4×10E6.

The embodiments of the invention described herein can operate in combination and cooperation, unless specified otherwise.

Furthermore, the various embodiments, although referred to as “preferred” or “e.g.” or “for example” or “in particular” and the like are to be construed as exemplary manners in which the invention may be implemented rather than as limiting the scope of the invention.

The term “comprising”, used in the claims, should not be interpreted as being restricted to for example the elements or the method steps or the constituents of a compositions listed thereafter; it does not exclude other elements or method steps or constituents in a certain composition. It needs to be interpreted as specifying the presence of the stated features, integers, (method) steps or components as referred to, but does not preclude the presence or addition of one or more other features, integers, steps or components, or groups thereof. Thus, the scope of the expression “a method comprising steps A and B” should not be limited to a method consisting only of steps A and B, rather with respect to the present invention, the only enumerated steps of the method are A and B, and further the claim should be interpreted as including equivalents of those method steps. Thus, the scope of the expression “a composition comprising components A and B” should not be limited to a composition consisting only of components A and B, rather with respect to the present invention, the only enumerated components of the composition are A and B, and further the claim should be interpreted as including equivalents of those components.

In addition, reference to an element or a component by the indefinite article “a” or “an” does not exclude the possibility that more than one of the element or component are present, unless the context clearly requires that there is one and only one of the elements or components. The indefinite article “a” or “an” thus usually means “at least one”.

While the invention has been described in terms of several embodiments, it is contemplated that alternatives, modifications, permutations and equivalents thereof will become apparent to one having ordinary skill in the art upon reading the specification. The invention is not limited in any way to the illustrated embodiments. Changes can be made without departing from the scope which is defined by the appended claims.

### BRIEF DESCRIPTION OF THE DRAWINGS

The present invention will be discussed in more detail below, with reference to the attached drawings, in which

FIG. 1: Cooling assembly 1 comprising a bulk first container 2, a cooling unit 7, a cooling receptacle 14 provided with a means 16 for cooling insect pulp;

FIG. 2: Cooling assembly 1 according to FIG. 1, further comprising a container 24 for providing heated insect pulp L1 in container 2;

FIG. 3: Cooling assembly 1 according to FIG. 1, further comprising cooling units 7a in addition to cooling unit 7, coupled serial from the upstream end of cooling unit 7 to the downstream end of the last cooling unit 7a, that is coupled to pipe p2;

FIG. 4: Cooling assembly 1 according to FIG. 1, further comprising a pipe p3 branching in fluid connection from pipe p2, pipe p3 provided with a valve v6, optionally provided with a driver d5, for flowing pre-cooled insect pulp L2 that is exiting cooling unit(s) 7, 7a, from pipe p2 back to container 2 through the opening at the downstream end 28 of branching pipe p3;

FIG. 5: Cooling assembly 1 according to FIG. 1, further comprising a second cooling receptacle 14a such as a cooling tank 14a in fluid connection with pipe p2 via a valve v7 and a pipe p5 ending with its end 29 in opening 29′ of cooling receptacle 14a;

FIG. 6: Cooling assembly 1 according to FIG. 1, further comprising a further container for insect paste L3 in fluid connection with pipe p2, cooling receptacle 14 such as tank 14, a tank outlet opening 17, a pipe p6 provided with valve v3 and driver d10, wherein the pipe p6 ends in a container 30 such as a tank 30;

FIG. 7: Cooling assembly 1 according to FIG. 1-6, wherein all features of FIGS. 1-6 are combined in a single embodiment of the cooling assembly 1;

FIG. 8: Cooling units 7, 7a for pre-cooling heated insect pulp L1 such that pre-cooled insect pulp L2 can exit the cooling units 7, 7a, each cooling unit being in serial fluid connection with a source of cooling liquid C1, for counter current heat exchange;

FIG. 9: 3D detail of the inner pipe 8 and the outer pipe 9 of a cooling unit 7, wherein the inner pipe 8 is suitable for flowing insect pulp and the outer pipe 9 is suitable for flowing cooling liquid c1 in a direction opposite to the direction of flowing insect pulp L1, L2;

FIG. 10: Cooling receptacle 14b here a tank 14b comprising a spiral tube 23 here a spirally winded hollow tube 23 inside the tank, arranged for receiving cooling liquid c2, the tank further provided with a means 18 for agitating here a stirrer 18 i.e. a rotor with blades 18 comprising blades and a motor R;

FIG. 11: Double-jacket cooling receptacle 14 here a double-jacket tank 14 comprising double jacket 20, a stirrer 18 with rotor blades and a motor R, the tank comprising an inlet opening 15 and an outlet opening 17 provided with a valve v3 and optionally a pipe p6 in fluid connection with the outlet opening and the valve;

FIG. 12: 3D drawing with cut-out, of a cooling receptacle 14, here tank 14 comprising a double jacket 20, a stirrer 18, an inlet opening 15, an outlet opening 17 in the bottom of the tank, the outlet opening in fluid connection with a pipe p6, the double jacket 20 connected via its inlet and outlet to a tube 22 for flowing cooling liquid c2 through the double jacket 20.

### DETAILED DESCRIPTION

It is a first goal of the present invention to provide an improved method, i.e. a faster (when the time required for providing insect paste at a temperature at 10° C. or below, from initially hot insect pulp at a temperature of e.g. 80° C. or higher, is considered) and improvingly controllable method, for cooling heated insect puree or pulp, and therewith for providing insect paste at a temperature of 10° C. or lower which insect paste has a sufficiently low microbial count (e.g. aerobic mesophilic plate count of less than 5×10E6), preferably an improved insect paste, wherein the improvement relates to any one or more of lower microbial load, increased appealing appearance, extended shelf life, good characteristics suitable for applying the insect paste as a food or feed product or as an ingredient in a food product or feed product.

It is an objective of the current invention to provide a method for providing insect paste which is accompanied by less cumbersome method steps when for example keeping the microbial load sufficiently low is considered, for example when time required for method steps for cooling of heated insect puree is concerned and/or when the required machinery and equipment is concerned required for faster and better controllable processing of heated insect pulp into a batch of sufficiently cooled insect paste with a sufficiently low microbial load, while in some embodiments at the same time the color and/or water holding capacity and/or protein dispersibility index is/are improved for the insect paste, when compared to more slowly cooled heated insect pulp according to less controllable methods applied in the art.

At least one of the above objectives is achieved by providing a method of the invention for providing insect paste at a temperature below 10° C. from heated insect pulp, wherein the microbial load is sufficiently low such that the insect paste is suitable for consumption or for further processing into food or feed ingredient or for use as a food or feed ingredient. At least a further objective is achieved by providing a cooling assembly for controllable and fast cooling of a batch of heated insect pulp to a temperature at or below 10° C., therewith providing insect paste of the invention, which insect paste has a sufficiently low microbial burden or count making it suitable for application as a food, feed, food ingredient or feed ingredient, of the invention.

The present invention will be described with respect to particular embodiments but the invention is not limited thereto but only by the claims.

An aspect of the invention relates to a method for batch-wise providing insect paste, the method comprising the steps of, or the method consisting of the steps of:
(a) providing heated insect pulp that is at a temperature of 45° C. or higher;
(b) cooling the heated insect pulp of step (a) in a first cooling phase to a temperature of 45° C.-35° C. within a first time period, therewith providing pre-cooled insect pulp; and
(c) cooling the pre-cooled insect pulp of step (b) in a second cooling phase that starts within a second time period starting at the end of the first time period of step (b), and that lasts for a third time period, to a temperature of below 35° C., therewith providing the batch of insect paste.

It is preferred that during the first cooling phase of step (b) of the method, the heated insect pulp is flowing during the cooling. It is preferred that during the second cooling phase of step (c) of the method, the pre-cooled insect pulp is stirred or mixed during the cooling.

The inventors established that it can be a challenge to provide a batch of insect paste with a sufficiently low microbial burden, when heated insect pulp at 90° C. is the starting source material, such as minced and heated black soldier fly larvae 9-15 days of age post hatching, typically 10-12 days of age or 14 or 14 days of age. That is to say, applying conventional techniques, a batch of, for example 50 liter-750 liter of heated insect pulp at about 90° C., is left standing still at ambient temperature such as room temperature for a time period until the insect pulp has adopted the ambient temperature. Alternatively, the insect pulp is left standing at ambient temperature until the temperature dropped to about 70° C. and subsequently the batch is placed in a cooling warehouse or a reefer, for example at 4° C. or at −20° C. Due to the volume of over e.g. 50 liter, and due to the semi-solid highly viscos mass of the pulp, heat exchange from the relatively high-temperature pulp to its air surrounding is slow for pulp standing still (i.e. non-agitated, non-stirred, non-rocked, non-mixed, etc.). It may take hours to days until the insect pulp is at e.g. 4° C. or −20° C. or 10°-−83° C., depending on the air temperature in the volume in which a container comprising the batch of heated insect pulp is placed. Typically it takes over 16 hours before a batch of such hot puree at 90° C. is for example cooled to ambient temperature and subsequently to e.g. 4° C. This slow cooling may hamper or decrease insect pulp shelf life due to a too high microbial count. Due to the slow cooling according to conventional methods, the insect pulp remains for a relatively long period of time of hours to days at a temperature that is beneficial to support microbial growth, i.e. a temperature of higher than 10° C., coming with the risk for too excessive microbial growth, therewith spoiling the batch of insect paste. In addition, the inventors surprisingly established that by applying the two-stage cooling method of the invention, an insect paste is provided which has a lighter overall appearance and surface color when compared to insect paste obtained from the same initial batch of heated insect pulp, but which is relatively slowly cooled while standing still, according to conventional methods for cooling insect pulp. Conventional cooling methods requires 12 hours to 2 days before an insect paste at the desired low temperature of for example 4° C. is provided, when heated insect pulp at 90° C. is applied. With the method of the invention, insect paste at a temperature below 10° C. can be provided from the same batch of heated insect pulp, though within a fraction of the time required when applying a conventional cooling method: a few hours to less than 45 minutes.

It is preferred that in the method according to the invention, in step (a) of the method the provided heated insect pulp is insect pulp obtained by the process steps of:
(i) providing insects, preferably insects that are washed, preferably washed with water;
(ii) preparing a pulp from the insects of process step (i); and
(iii) heating the insect pulp of process step (ii) for 50 seconds-1 hour, preferably for 55 seconds-30 minutes, more preferably 65 seconds-10 minutes, most preferably 70 seconds-5 minutes, at a temperature of 60° C.-100° C., preferably 85° C.-95° C., and optionally subsequently cooling to a temperature of 45° C.-99.5° C., optionally 60° C.-95° C.,
   therewith providing the heated insect pulp of step (a) of the method.

Preferably the heated insect pulp is pasteurized in response to process step (iii).

The insect paste according to the invention is preferably not enzymatically treated. In particular, the insect pulp is not enzymatically treated, such as not enzymatically treated before the step (a) of providing the heated insect pulp.

Alternatively, the insect paste according to the invention may be enzymatically treated. In a particular embodiment, the insect pulp is enzymatically treated, such as enzymatically treated before the step (a) of providing the heated insect pulp.

The inventors established that the controllable and relatively fast cooling method of the invention is applicable with heated insect pulp that was pasteurized according to process step (iii). Any of the selected pasteurization times and/or any of the selected pasteurization temperatures are applicable for pasteurizing insect pulp such as minced BSF larvae, and subsequently subjecting the heated insect pulp to step (b) of the method. In particular, heated insect pulp provided according to process steps (i)-(iii) of step (a) of the method, is suitable for performing the step (b) of the method while the heated insect pulp is flowing. Viscosity of said heated insect pulp allows transportation of the pulp through for example a tube or pipe, and the pulp is for example moveable using a driver such as a pulling or pushing pump. Under flow, heat exchange between the heated insect pulp and the volume of gas or liquid surrounding the heated insect pulp, which gas or liquid is typically at a lower temperature (e.g. ambient temperature or room temperature, or at a temperature below room temperature such as 4° C.-14° C. or about 9° C.-13° C.) than the temperature of the heated insect pulp, is more efficient compared to heated insect pulp that is not flowing and that is non-agitated kept at a constant position during step (b), e.g. standing still in a receptacle during the first cooling phase. Flowing heated insect pulp allows for application of for example counter current heat exchange between the heated insect pulp and a (chilled or cooled) cooling fluid flowing in opposite direction compared to the direction of flow of the pulp. The time required to cool the heated insect pulp in step (b) of the method is shorter when the heated insect paste is for example flowing along the inner side of a wall of a receptacle, e.g. a tank or pipe, wherein the outer side of said wall is in contact with a fluid such as a cooling gas or a cooling liquid such as water, which is at a lower temperature than 35° C., compared to the time required to cool the heated insect pulp to 35° C.-45° C. when the heated insect pulp is standing still in the receptacle (e.g. counter current heat exchange). For example, it takes over 12 hours to 2 days before a batch of about 400 liter heated BSF larvae pulp at 90° C. is cooled to 35° C. when the batch of heated insect pulp is left standing still in a plastic container at room temperature. In contrast, by applying the method of the invention with a batch of the similar volume at the similar temperature, the BSF larvae pulp is cooled in less than 10 minutes to 35° C. by applying the method of the invention. Since insect pulp that is pasteurized for 10 minutes or shorter, e.g. for 70 seconds-5 minutes or 80 seconds-160 seconds, has a lower viscosity compared to insect pulp that is pasteurized for a time period exceeding e.g. 10 minutes such as 30 minutes-1 hour, it is preferred to apply heated insect pulp in the method of the invention that is pasteurized as shortly as possible when heated insect pulp with a sufficiently low microbial count is considered. “Sufficiently low” refers to a microbial count that allows application of the final insect paste as food, feed, a food ingredient, a feed ingredient, or as a source for isolating e.g. protein or oil, suitable for use in production of a feed or food stuff. The inventors established that for example pasteurization at 90° C. for 80 seconds, 160 seconds, 5 minutes and 30 minutes is sufficiently long and enough for providing heated insect pulp in step (a) of the method and for providing insect paste at the end of step (c) of the method, with a sufficiently low microbial count of less than 10 cfu/g Enterobacteriaceae in the pulp and paste and an aerobic mesophilic plate count of less than 20×10E6, preferably less than 10×10E6, more preferably an aerobic mesophilic plate count of less than 5×10E6, in the pulp and paste. In (large scale) batches of the insect paste provided with the method of the invention, the insect paste comprises regularly less than 10 cfu/g Enterobacteriaceae and an aerobic mesophilic plate count of less than 15×10E6, or less than 12×10E6 or even less than 9×10E6, such as 5×10E6-8×10E6 or lower such as an aerobic mesophilic plate count of less than 4×10E6. ‘Large scale’ in the context of the invention is a volume of insect paste of 1 liter or more, such as 10-10.000 liter, or 100-1.000 liter. Similar microbial counts are obtainable for insect paste provided at smaller scale with the method of the invention.

As said, preferably, the pre-cooled insect pulp is stirred or mixed or agitated during step (c) of the method. This is for similar reasons as outlined for the flowing heated insect pulp during step (b) of the method. The inventors established that down to a temperature of about 35° C. in step (b) of the method, the pulp is pumpable and can flow with relative ease through for example tubes and pipes with an inner diameter of 10 cm or less such as 2.5 cm-8 cm, due to sufficiently low viscosity of the heated insect pulp and the pre-cooled insect pulp. At a temperature of lower than 35° C., fat and oil in the pulp may crystallize and/or solidify, both resulting in increased viscosity of the pulp, and in general, at lower temperature than 35° C., the viscosity of the pulp further increases. The inventors established that such pulp at a temperature lower than 35° C. can still flow, and can still be transported through a pipe, tube or hose, for example with the aid of gravity and/or a driver such as a pushing and/or pulling pump. However, the inventors established that it is suitable to agitate or stir or mix the pre-cooled insect pulp during step (c) of the method, in order to establish constant flow along the inner side of a receptacle containing the pre-cooled insect pulp during step (c). For example, a stirrer or rotor with blades in the center of a tank comprising the pre-cooled insect pulp, is sufficient and enough to establish constant movement of the pulp along the tank wall. Movement of pre-cooled insect pulp along the wall of a receptacle allows for improved and faster heat exchange between the relatively warm pre-cooled insect pulp in the receptacle such as a tank or container, e.g. pre-cooled insect pulp at a temperature of 35° C.-45° C. at the start of step (c), decreasing to e.g. 2° C.-7° C. during the course of step (c) of the method, and the relatively cool or cold surrounding volume of fluid such as a cooling gas, air, cooling liquid such as (cooled) (tap) water, a (chilled) water-glycol mixture, encompassing the receptacle (e.g. by counter current heat exchange). Typically, in step (c) of the method, the outer wall of the receptacle which comprises the pre-cooled insect pulp, is contacting a flowing cooling liquid at a temperature below 2° C. Agitating or stirring or mixing the pre-cooled insect pulp in the receptacle creates constant movement of the pulp along the inner side of the wall of the receptacle, which inner side of the wall is constantly cooled by contacting the outer side of the wall with a fluid which has a lower temperature than the pre-cooled insect pulp and the insect paste in step (c) of the method. Thus, by agitating, stirring or mixing, the pre-cooled insect pulp is faster cooled compared to pulp at the same initial temperature which is standing still in the same receptacle. Indeed, the inventors established that in step (c) of the method a batch of pre-cooled insect pulp at 35° C.-45° C. can be cooled to 3° C.-6° C. within 1 hour and even within 30 minutes, when the outer wall of a receptacle is contacted with flowing water-glycol mixture at −2.8° C., and when the pre-cooled insect pulp is stirred with a rotor with blades, when for example the batch of pulp was about 400 liter.

It is also preferred that in the method according to the invention, the heated insect pulp of method step (a) is derived from insect larvae, preferably from black soldier fly larvae.

Optional is the method of the invention, wherein the heated insect pulp of method step (a) is derived from insect larvae, preferably from black soldier fly larvae, wherein said larvae are between 8 and 30 days of age, preferably between 10 and 28 days, more preferably 12-26 days, most preferably at an age 12 hours-3 days before the larvae transform into prepupae, such as 1-2 days before said transformation, and more preferably, the heated insect pulp of step (a) of the method is derived from black soldier fly larvae that are 10-20 days of age or that are at an age 12 hours-3 days before the black soldier fly larvae transform into prepupae.

The inventors established that efficient pasteurization of minced BSF larvae of 9-16 days of age such as 10-14 days of age post hatching, can be executed for an as short heating time as 300 seconds or less, as tested at pasteurization times of 80 seconds, 160 seconds and 300 seconds, at 90° C. Such short term pasteurization is sufficient and enough for arriving at heated insect pulp and subsequent insect paste after applying the method of the invention, when the microbial count is considered, which is suitable for application of the insect paste as a food, feed, food ingredient or feed ingredient. Conventionally, minced BSF larvae are heated at 90° C. for longer than 5 minutes such as for 30 minutes. Surprisingly, when applying the method of the invention with such long-term pasteurized heated insect pulp did not result in insect paste with a lower microbial count, compared to shortly pasteurized insect pulp (5 minutes or shorter, e.g. less than 260 seconds). In contrast, shortly pasteurized minced BSF larvae also had a better color appearance, i.e. an overall lighter color, reduced water loss when subjected to heat stress (see Examples section) and an improved, i.e. higher, protein dispersibility index. Therefore, it is preferred to start step (b) of the method of the invention with heated insect pulp that was only pasteurized for a relatively short time span of less than 30 minutes, preferably at most 5 minutes, and preferably shorter such as 200 seconds or less, e.g. between 65 seconds and 190 seconds, although heated insect pulp that was pasteurized for e.g. 10 minutes-1 hour can also be applied in the method of the invention. Since longer pasteurization may result in increased viscosity of the pulp and/or in (undesired) darkening and Maillard reactions, and since in step (a) of the method, a longer pasteurization time extends the time required for the method to deliver the insect paste, a relatively short pasteurization time during process step (iii) of method step (a) is preferred. Of course, a minimal pasteurization time at 90° C. is required in order to be able to arrive at an insect paste with a sufficiently low microbial load. The inventors previously established that pasteurization for 80 seconds±2 seconds is certainly sufficient for the provision of an insect paste with a microbial count such that the insect paste is suitable for consumption. The lower pasteurization time limit appears to be about 50 seconds, and preferably in the method of the invention, heated insect pulp is provided in step (a) which is pasteurized for a somewhat longer time period such as 65-300 seconds, or 70 seconds-280 seconds, 75 seconds-180 seconds.

Preferably, the heated insect pulp of method step (a) is pulp from particulized insects such as granulated, minced, ground, cut, blended, smashed insects, preferably insect larvae such as BSF larvae. Preferred is the method of the invention, wherein the process step (ii) of the method step (a) comprises or consists of:
(ii) mincing the insects of process step (i) of the method step (a), therewith providing the insect pulp for subsequent process step (iii) of the method step (a). The insect is preferably BSF larvae.

Typically, in the method of the invention, the average particle size of remains of the insects in the insect pulp of step (a) of the method is in the range of 10 micrometer-500 micrometer, preferably in the range of 25 micrometer-400 micrometer, more preferably in the range of 40 micrometer-300 micrometer, most preferably in the range of 50 micrometer-250 micrometer. Typically, the particulized insects are minced larvae such as minced BSF larvae. For homogenous and fast heating and pasteurizing BSF larvae, the pre-step of reducing larvae in size, by for example mincing, is suitable and preferred. Small larvae particles are efficiently heated and pasteurized. Particles at a size of on average 500 micrometer or smaller are efficiently pasteurized at form example 1 liter-700 liter scale in a container provided with means for agitating the minced larvae during heating. The smaller the particulated minced larvae are, also the subsequent cooling steps (b) and (c) proceed efficiently. Although, the method of the invention is also applicable for heated insect pulp predominantly or partly comprising insect particles at sizes larger than 500 micrometer. A pulp with smaller-size pulp particles is however preferred.

Optionally, in the method of the invention, in process step (iii) of the method step (a) the insect pulp is heated for 60-180 seconds, preferably at a temperature of 80° C.-98° C., preferably for 75-160 seconds, preferably at a temperature of 85° C.-95° C., more preferably for 77-120 seconds, more preferably at a temperature of 87° C.-93° C., most preferably for 80 seconds±2 seconds, most preferably at a temperature of 90° C.±2° C., therewith providing the heated insect pulp of step (a) of the method. Pasteurizing for, for example, as short as 80 seconds or 160 seconds, at 90° C., proved to be efficient and enough to arrive at insect paste provided with the method of the invention, when the microbial count is considered. Moreover, overall light color, a beneficially low water loss in the WHC test and/or a beneficially high PDI and/or a more fine porridge-like appearance, were apparent for insect paste obtained with the method of the invention when in step (a) such as shortly pasteurized pulp was applied, compared to insect paste provided with the method of the invention wherein in step (a) pasteurization time applied was longer than 5 minutes. Of course, the method of the invention is equally suitable for providing insect paste such as BSF larvae paste, from heated insect pulp that was pasteurized for a prolonged time longer than 5 minutes-10 minutes, such as 15 minutes-1 hour or 20 minutes or 30 minutes. If further processing or use of the insect paste provided with the method allows a relatively darker color of the paste, and/or a relatively higher water loss of more than 10%, when heated, and/or a protein dispersibility index of, for example, less than 40%, the method of the invention is applicable for providing insect paste from heated insect pulp that was pasteurized for longer than 5 minutes. Surprisingly, the method of the invention provides relatively light-colored paste, which can have a relatively improved WHC (reduced water loss when heated), and which can have a relatively high PDI, when heated insect paste is applied in step (b) of the method which was pasteurized for 10 minutes or shorter, preferably for 5 minutes or shorter, e.g. 70 seconds-5 minutes or 75 seconds-240 seconds.

Preferred is the method of the invention, wherein in process step (iii) of the method step (a) the insect pulp is heated for 80 seconds±2 seconds at a temperature of 90° C.±2° C., therewith providing the heated insect pulp of step (a) of the method. Also suitable and preferred is the method of the invention, wherein in process step (iii) of the method step (a) the insect pulp is heated for 70-180 seconds±5 seconds at a temperature of 90° C.±4° C., therewith providing the heated insect pulp of step (a) of the method. Also part of the invention is insect paste obtained with the method of the invention, or obtainable with the method of the invention, wherein in process step (iii) of step (a) of the method, the insect pulp of process step (ii) is heated for 10 minutes or less, preferably for 8 minutes or less, more preferably for 6 minutes or less, most preferably for 5 minutes or less, such as 70 seconds-10 minutes, 70 seconds-5 minutes or 75 seconds-200 seconds, at a temperature of 80° C.-100° C., preferably 85° C.-95° C., more preferably 90° C.±3° C., most preferably 90° C.±2° C., therewith providing the heated insect pulp of step (a) of the method.

Typically, for the method of the invention, the heated insect pulp provided in method step (a) is at a temperature of 45° C.-100° C., optionally 50° C.-97° C., 55° C.-95° C., or 60° C.-93° C. Typically, BSF larvae such as minced BSF larvae are provided, typically at 70° C.-99° C. Preferred is the method of the invention, wherein the heated insect pulp provided in method step (a) is at a temperature of 65° C.-98° C., optionally 75° C.-95° C., 85° C.-93° C., or 90° C.±2° C. As said, for example minced BSF larvae can be pasteurized at for example about 90° C. in order to provide insect paste with the method of the invention, which as a sufficiently low microbial count. It is preferred that in step (a) of the method the pasteurized (heated) insect pulp is provided directly following the end of the pasteurization step, although step (b) may start at a time point at which the initially heated insect pulp of step (a) is at a temperature above 45° C., but heated insect pulp at a temperature close to the pasteurization temperature is preferred.

Optional is the method of the invention, wherein in the first cooling phase of step (b) of the method the heated insect pulp is cooled to a temperature of 45° C.-36° C., preferably to 43° C.-38° C. Typically, the heated insect pulp is cooled to a temperature at which the insect pulp does not solidify, such as solidification due to solidifying fat in the pulp. In other words, the insect pulp in step (b) of the methods is cooled to a temperature and remains at a temperature which is above the temperature at which the fat in the pulp starts solidifying. Typically the lower limit temperature in step (b) of the method of the invention is 35° C., for example when BSF larvae are minced and heated such that heated BSF larvae pulp is cooled in step (b). The inventors established that the highly viscos heated insect pulp such as the BSF larvae pulp is still pumpable through pipes and tubes, for example with an inner diameter of 8 cm or less, such as 2 cm-8 cm, or 3 cm-5 cm. Such flowing heated insect pulp at e.g. 70° C.-95° C. does not solidify, or for example the fat in the heated insect pulp does not solidify when the temperature of the heated insect pulp remains 35° C. or higher. Therefore, by cooling the heated insect pulp in the step (b) of the method to a temperature not lower than 35° C. allows for efficient and fast flowing the pre-cooled insect pulp through e.g. pipes and tubes, with the aid of a driver such as a pulling pump or pushing pump. This is beneficial when for example the insect pulp requires transportation from a first location, e.g. the pasteurization location (a container) to a second location such as a storage container. Moreover, insect pulp at relatively lower viscosity allows for mixing or agitating the pulp during transportation and/or during cooling in step (b) of the method. In addition, at a temperature at or above 35° C., the pulp remains more homogeneous.

The first cooling phase of step (b) of the method is a relatively fast phase that shortly lasts for less than 1 hr, and more in particular in the range of less than 10 minutes. Typically, in the method of the invention, in the first cooling phase of step (b) of the method the first time period is 2 seconds-30 minutes, preferably 5 seconds-20 minutes, more preferably 10 seconds-10 minutes, most preferably 30 seconds-5 minutes, such as 1 minute-4 minutes, till the pre-cooled insect pulp is provided. Typically, a batch of 200 liter-800 liter of heated BSF larvae pulp is cooled to not lower than 35° C. in three minutes or in 2 minutes-5 minutes, wherein the temperature at the end of step (b) is about 35° C.-45° C. At these temperatures, the oil and fat in the pulp does not crystallize or solidify and the insect pulp is relatively easily transportable by e.g. flowing the pre-cooled pulp through a line such as a tube, pipe, etc.

One of the many benefits of the method of the invention is that it lasts for a relative short duration from the start with heated insect pulp till the end, at which insect paste is provided. The heated insect pulp is very fast cooled to a temperature of 45° C. or below (but not lower than 35° C.), such that the time window within which microbial growth could occur is relatively short. Indeed, the inventors established that insect paste provided with the method of the invention has a similar microbial count or lower, compared with insect pulp provided conventionally (e.g. heating minced BSF larvae for up to 30 minutes at 90° C. and leaving the heated insect pulp at ambient temperature till the pulp temperature decreases to 70° C. or below, such as room temperature, optionally followed by storing the batch of pulp at 4° C. or at −20° C.). Thereafter, method step (c) is started as quick as possible, to further cool the insect pulp to a temperature at which microbial growth is reduced to a large extent or even essentially stopped. In the method of the invention, particularly in the step (c) of the method the second time period starts at 0 seconds-45 minutes since the end of the first time period of step (b) of the method, preferably at 5 seconds-30 minutes, more preferably at 10 seconds-20 minutes, most preferably at 20 seconds-10 minutes, such as 30 seconds-5 minutes or 1 minute-3 minutes. Basically, the method step (c) is applied as shortly after the end of method step (b) as possible, since it is preferred that the insect paste is provided as quickly as possible at a temperature that largely reduces the risk for microbial growth and reduces the chance for drying out of the product. Once the insect paste is provided in step (c) of the method, the insect paste can be stored at low temperature (8° C. or lower), for example in a closed container. Indeed, the inventors established that by applying the method of the invention, in a relatively short time period of for example less than 90 minutes, less than 60 minutes, less than 40 minutes, and even in 30 minutes or less, insect paste can be provided at sufficiently low temperature, such that the risk for a too high microbial load is highly reduced or even diminished or excluded.

Cooling the heated insect pulp as quickly as possible to a temperature below ambient temperature and even to a temperature below 0° C., is beneficial to diminishing microbial growth. Preferred is the method of the invention, wherein in the step (c) of the method the third time period is 10 minutes-6 hours, preferably 20 minutes-5 hours, more preferably 30 minutes-4 hours, most preferably 40 minutes-3 hours, such as 50 minutes-2.5 hours or 1 hour-2 hours.

In cooled insect paste or frozen insect paste, microbial growth is halted to a large extent, or is even stopped. Typically, in the method of the invention, in the step (c) of the method the pre-cooled insect pulp of step (b) is cooled to a temperature of 12° C.-0° C., preferably 10° C.-2° C., more preferably 8° C.-3° C., most preferably 7° C.-4° C., such as 9° C.-1° C. or 7° C.-3° C.

Of course, it is also part of the invention to provide insect paste at temperatures below 0° C. (frozen insect pulp). Such pulp may have a longer shelf live when microbial overgrowth is considered or when other quality parameters are considered such as WHC, texture, taste. Therefore, it is also part of the invention that in the step (c) of the method the pre-cooled insect pulp of step (b) is cooled to a temperature of 0° C.-−83° C., preferably −4° C.-−63° C., more preferably −8° C.-−43° C., most preferably −10° C.-−23° C., such as −1° C.-−30° C. or −2° C.-−15° C., therewith providing the insect paste, or when depending on claim 15, the insect pulp is further cooled in a subsequent step (d) of the method, to a temperature of 0° C.-−83° C., preferably −4° C.-−63° C., more preferably −8° C.-−43° C., most preferably −10° C.-−23° C., such as −1° C.-−30° C. or −2° C.-−15° C., therewith providing the insect paste.

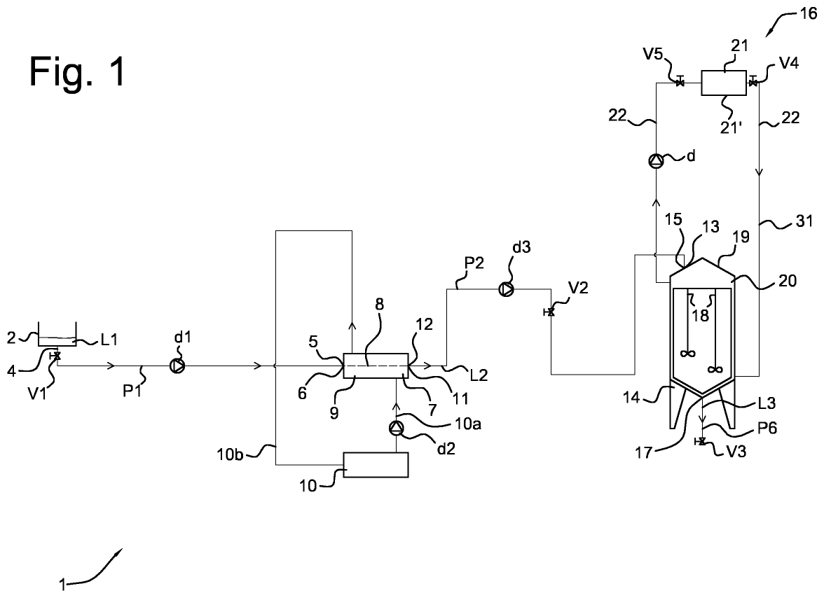

As outlined here above, the inventors established that the heated insect pulp applied in step (b) of the method can flow and can be transported by using a pump, with relative ease. This makes fast cooling by applying counter current heat exchange possible in step (b). Therefore, it is part of the invention that in the method step (b) the cooling is for example cooling by applying counter current heat exchange. Typically, for establishing the counter current heat exchange, the heated insect pulp flows through an inner pipe, which is held concentrically inside an outer pipe, in a first direction and wherein a cooling medium such as a liquid such as water flows through the outer pipe along the concentrically held inner pipe in a second direction opposite to the first direction, or wherein the cooling liquid such as water flows through said inner pipe in the first direction and wherein the heated insect pulp flows through the outer pipe along the concentrically held inner pipe in said second direction. See for example FIG. 1, 8, 9. Since counter current heat exchange is a highly sufficient way of fast cooling a suspension or pulp like the heated insect pulp, flowing the heated insect pulp during step (b) of the method is preferred, making the application of the counter current heat exchange possible.

As outlined here above, the inventors established that the pre-cooled insect pulp provided with method step (b) can still flow and be transported with the aid of for example a pump, and that the pre-cooled insect pulp and the insect paste provided in step (c) of the method, can be stirred, mixed or agitated for example with the use of a stirrer or rotor with blades. Since due to the cooling of step (b) of the method, the viscosity of the pre-cooled insect pulp is increased compared to the heated insect pulp, and since the viscosity of the insect paste provided in step (c) of the method is higher than the viscosity of the pre-cooled insect paste, it is preferred to stir or mix the pre-cooled insect pulp during step (c). Therefore, it is part of the invention that in the method step (c) the cooling of the pre-cooled insect pulp is cooling using a double-jacketed tank containing the pre-cooled insect pulp, wherein the pre-cooled insect pulp is agitated, stirred or mixed in the tank, while a cooling liquid such as water or a water:glycol mixture, is flowing through the double jacket that at least partly encompasses the tank, or wherein in the method step (c) the cooling of the pre-cooled insect pulp is cooling using a tank comprising a coiled tube in the inner volume of the tank, the tank containing the pre-cooled insect pulp such that the pre-cooled insect pulp contacts at least part of the coiled tube, wherein the pre-cooled insect pulp is optionally agitated, stirred or mixed in the tank, while a cooling liquid such as a water:glycol mixture, is flowing through the coiled tube.

The method of the invention can be applied at relatively small scale (grams to few hundred of grams) and at relatively large scale, suitable for industrial scale production of insect paste such as BSF larvae paste, for example a scale of 1-20 batches of insect paste per 24 h wherein each batch has a volume of for example 5 liter-4.000 liter. Therefore, according to the invention, the method provides a batch of insect paste consisting of for example 8 liter-20.000 liter insect paste, preferably 16 liter-10.000 liter, more preferably 32 liter-5.000 liter, most preferably 64 liter-2.500 liter. Preferably, such a batch volume can be provided more than one time per day, and indeed, since the method can take a short time period of less than 2 hours or even less than 1 hour, more than one batch per day can be provided when a single assembly for use in the method is available or applied. Pasteurization time in process step (iii) of method step (a) can be as short as 70 seconds-6 minutes, such as about 80 seconds-160 seconds, in order to provide heated insect pulp with a sufficiently low microbial count; step (b) of the method can last for less than 10 minutes such as 3-6 minutes, typically when the heated insect paste is subjected to counter current heat exchange; in step (c) the pre-cooled insect pulp can be cooled from 35° C.-45° C. down to 2° C.-6° C. in less than 90 minutes, even in 1 hour or less and typically in less than 45 minutes such as in 30 minutes. An embodiment is the method of the invention, wherein the method provides a batch of insect paste consisting of between 64 liter-2.500 liter insect paste, preferably consisting of 128 liter-1.250 liter, more preferably 200 liter-800 liter, most preferably 300 liter-600 liter. As said, provision of smaller volumes of insect paste or larger volumes of insect paste is equally suitable when applying the method of the invention.

Equally preferred is the provision of insect paste with the method, wherein batches of insect paste are expressed as a mass. Therefore, the method of the invention provides a batch of insect paste consisting of 10 kg-20.000 kg insect paste, preferably 20 kg-10.000 kg, more preferably 40 kg-5.000 kg, most preferably 80 kg-2.500 kg. More specifically, the method can provide for example a batch of insect paste consisting of between 80 kg-2.500 kg insect paste, preferably consisting of 120 kg-1.250 kg, more preferably 200 kg-800 kg, most preferably 300 kg-600 kg.

To the surprise of the inventors, pre-cooled insect pulp and even insect paste provided in step (c) of the method is still transportable by driving the semi-solid highly viscos pulp or paste through for example a tube, hose or pipe. Such pulp or paste consists of minced insects such as minced BSF larvae, which are pasteurized by for example heating at 90° C., and subsequently cooled in two steps. The relatively thick, high-viscosity pulp and paste consists for 100% of insects. Still, viscosity is low enough for allowing e.g. pumping and mixing or stirring, therewith making transportation by use of a pump, counter current heat exchange for cooling, and delivery of batches of insect paste at a determined and controllable size, possible. Of course, the method of the invention is also applicable for providing diluted insect paste, wherein for example the heated insect pulp or pre-cooled insect pulp or insect paste is diluted with a liquid such that the viscosity of the pulp or paste decreases. Therefore, it is part of the invention that in the method, in any one or more of method step (a), method step (b) and method step (c) a diluent, such as water or an oil, is mixed with the pulp or the paste, such that the heated insect pulp provided in method step (a) and/or the pre-cooled insect pulp provided in method step (b) and/or the insect paste provided in method step (c) comprises 0%-95% by weight of the diluent, based on the total weight of the heated insect pulp, the pre-cooled insect pulp and/or the insect paste, such as 5%-80% by weight, 10%-70% by weight, 20%-60% by weight, or 30%-50% by weight. This way, the method is applied with a pulp or paste at lower viscosity compared to the method wherein the heated insect pulp, the pre-cooled insect pulp and the insect paste are kept undiluted, i.e. consist for 100% of insect derived material (minced larvae, for example, typically BSF larvae).

An aspect of the invention relates to a cooling assembly 1 for batch-wise provision of insect paste, comprising:
a first container 2 for containing heated insect pulp L1; the first container being in fluid connection with the upstream end 4 of a first pipe p1; the first pipe optionally comprising a first driver d1 such as a pump;
the first driver being configured for driving heated insect pulp L1 through the first pipe p1 towards the downstream end 5 of the first pipe; the downstream end 5 of the first pipe p1 being in fluid connection with the upstream end 6 of an inner pipe 8 of a first cooling unit 7; wherein
the first cooling unit 7 is arranged for counter current heat exchange and comprises the inner pipe 8 which is held concentrically inside an outer pipe 9 of the first cooling unit 7; wherein the outer pipe 9 is in fluid connection with a source 10 of a first cooling medium c1 and a second driver d2; the second driver d2 being configured for flowing the first cooling medium c1 through the outer pipe 9 in opposite direction to heated insect pulp L1 flowing through the inner pipe 8 of the first cooling unit 7, wherein
the downstream end 11 of the inner pipe 8 of the first cooling unit 7 is in fluid connection with the upstream end 12 of a second pipe p2; the second pipe p2 optionally comprising a third driver d3 such as a pump; the third driver d3 being configured for driving pre-cooled insect pulp L2 exiting from the first cooling unit 7 through the second pipe p2 towards the downstream end 13 of the second pipe p2; wherein
the downstream end 13 of the second pipe p2 ends in a first cooling receptacle 14, 14a, and preferably the downstream end 13 of the second pipe p2 is in fluid connection with a first inlet 15 of the first cooling receptacle 14, 14a; wherein
the first cooling receptacle 14, 14a is provided with a first means 16 for further cooling pre-cooled insect pulp L2 when present in the first cooling receptacle 14, 14a, and with a means 18 for agitating such as a rotor with blades 18, a mixer 18, a stirrer 18; wherein
the first cooling receptacle 14, 14a is provided with a first outlet 17 configured for discharging insect paste from the first cooling receptacle 14, 14a; and
wherein the cooling assembly 1 comprises at least one of the first driver d1 and the third driver d3. See also FIG. 1, 8-12. The driver(s) can be a pump. Optionally, further valves and/or further pumps are applied in pipe p1 and/or pipe p2. Cooling receptacle 14 is optionally provided with an opening 17 in the bottom of the receptacle such as a tank such as a double-jacket tank. The opening 17 is for example in fluid connection with a pipe p6 provided with an optional valve v3, for release of the insect paste from the cooling receptacle 14.

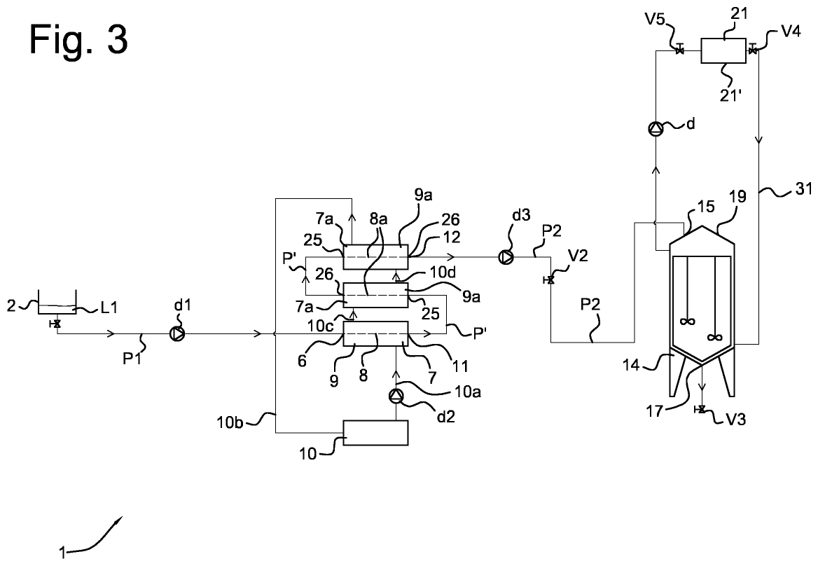

Since (heated) insect pulp and insect paste at a temperature of for example between 0° C. and 100° C. has a varying but overall relatively high viscosity, flowing, e.g. by pumping, and stirring such pulp and paste is not trivial when for example fast cooling within 2 hours to 2° C.-6° C. is aimed for when heated insect pulp at for example 90° C. is provided. Fast cooling of a highly viscos puree, paste or pulp, which may have characteristics reminiscent to a semi-solid material or suspension, at the other hand, benefits from application of counter current heat exchange. Challenging for (fast) flowing insect pulp or paste, required for fast cooling by counter current heat exchange, is the phase transition that may occur in the insect pulp or paste, during cooling. It has previously been established by the inventors that typically in heated insect pulp, at temperatures below 35° C. a phase transition in the pulp can occur: crystallization of fat and oil, and/or solidification of said fat and oil in the pulp matrix. Such phase transition increases the viscosity of the pulp. The inventors established that the heated insect pulp at a temperature of 35° C.-100° C. and the pre-cooled insect pulp at a temperature of 35° C.-45° C., as provided in step (a) and step (b) of the method of the invention, still have a viscosity that allows flowing (e.g. with the aid of one or more drivers) of the pulp through a cooling unit 7 that is connected to pipes p1 and p2, at a velocity that is sufficiently high such that the pulp can be cooled from e.g. 100° C. to 35° C.-45° C. within a sufficiently short time period (e.g. 2 minutes-30 minutes, typically 4 minutes or less), without clogging the pipe(s) and/or cooling unit(s) with insect pulp which has an increasing viscosity during the course of the cooling and the transport from container 2 to cooling receptacle 14. Typically, the diameter of the pipes p1 and p2 and the diameter of the inner tube 8 of the cooling unit 7 is less than 10 cm such as 2 cm-7 cm. Typically, the total length of the one or more inner tubes 8, 8a of one or more serial connected cooling units 7, 7a (see FIG. 3, 7, 8) is in total 5 m-250 m, such as 20 m-100 m. Typically, the total volume of pipe p1, pipe p2 and the inner pipes 8, 8a of the one or more cooling units is equal to or exceeds the volume of a typical batch of insect paste provided with the method of the invention. That is to say, the volume of heated insect pulp which can be contained by container 2 is about the volume which can be encompassed by the pipe p1, pipe p2 and cooling units 7, 7a. In addition, the volume of heated insect pulp and pre-cooled insect pulp which can be held by the pipe p1, pipe p2 and cooling units 7, 7a is about the same volume of insect paste or pre-cooled insect pulp which can be contained by a cooling receptacle 14.

The cooling assembly 1 is scalable and controllable. Length and diameter of pipes p1 and p2 and inner pipes 8, 8a of cooling units 7, 7a can be varied, corresponding to desired volumes of insect pulp to be cooled. In addition, the number of cooling units 7, 7a in the cooling assembly 1 can be adapted such that the required cooling capacity is achieved for a desired batch volume of heated insect pulp to be cooled by applying the cooling assembly in the method of the invention. Typically, the modular nature of the cooling assembly 1 easily allows serial coupling of further or less cooling units 7, 7a, such that the selected volume of heated insect pulp to be cooled is highly flexible adapted to. This is particularly convenient, since the diameter of pipes p1, p2, 8, 8a can remain constant, as well as the length of individual cooling units 7, 7a. Based on the viscosity of the specific insect pulp to be cooled, the number of drivers can be adapted. For example, one or more drivers d1 are connected to pipe p1, and/or one or more drivers d3 are connected to pipe p2. Of course, it is beneficial for the cooling rate in cooling units 7, 7a, when pipes with a relatively small inner diameter are applied in the cooling assembly 1. Therefore, typically, the inner diameter of the pipes in the cooling assembly is 5 cm or less.

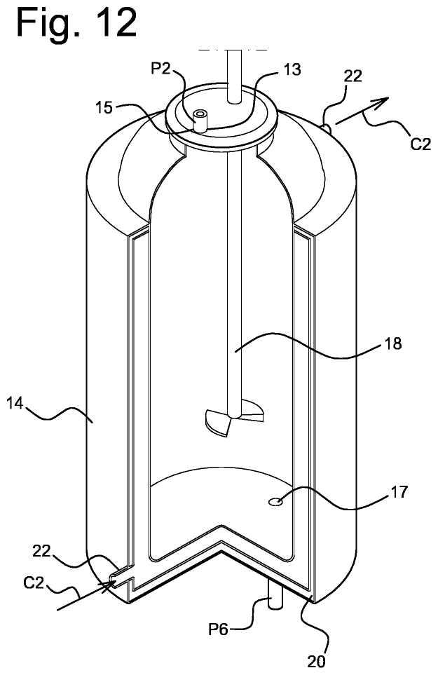

An embodiment is the cooling assembly 1 according to the invention, wherein the first means 16 for further cooling being a tank 19 comprising a double jacket 20 configured for flowing a second cooling medium c2 through the double jacket 20 and in fluid connection with a source of second cooling medium via a tube 22 provided with a driver d, such that insect paste L3 can be produced by cooling pre-cooled insect pulp L2 contained in the first cooling receptacle 14, 14a when the cooling assembly 1 is in operation. See also FIGS. 1-7, 11 and 12. Such as tank 19 comprising a double jacket 20 provides for a highly efficient way of cooling high-viscos pre-cooled insect pulp at a temperature of 0° C.-45° C., typically 2° C.-35° C. The double jacket preferably encompasses the whole outer wall of the tank 19 such that heat exchange between the content of the tank 19 and the cooling fluid c2 such as water or preferably water-glycol at −1° C.-−5° C. such as −2.8° C., is optimal. Presence of the means 18 for agitating or stirring the tank content L2, such as a stirrer 18 comprising a rotor with blades and a motor R, further contributes to efficient cooling of the contents L2 of the tank 19, by counter current heat exchange along the wall of the tank 19. Indeed, the inventors established that insect pulp and insect paste at such low temperature of 0° C.-45° C. can still be sufficiently mixed or stirred in tank 19, such that the whole volume L2 moves and flows along the side wall of the tank 19, allowing efficient and relatively fast further cooling of the pre-cooled insect pulp L2. At the same time, the inventors established that by applying the tank 19 with means for stirring 18 for mixing and cooling insect pulp requires energy and force for the stirring that can be provided with a motor known in the art that does not heat up the environment of the cooling assembly 1 to a large extent, if at all, for example when a batch of 10 liter-1000 liter is cooled in a tank 19 of the cooling assembly 1. This is beneficial, since the insect paste can be produced at a significant industrial scale by applying the cooling assembly 1 of the invention in the method of the invention, while at the same time no further means for cooling the motor of the means 18 for stirring is required, and/or a further means for cooling the surrounding of the cooling assembly 1.

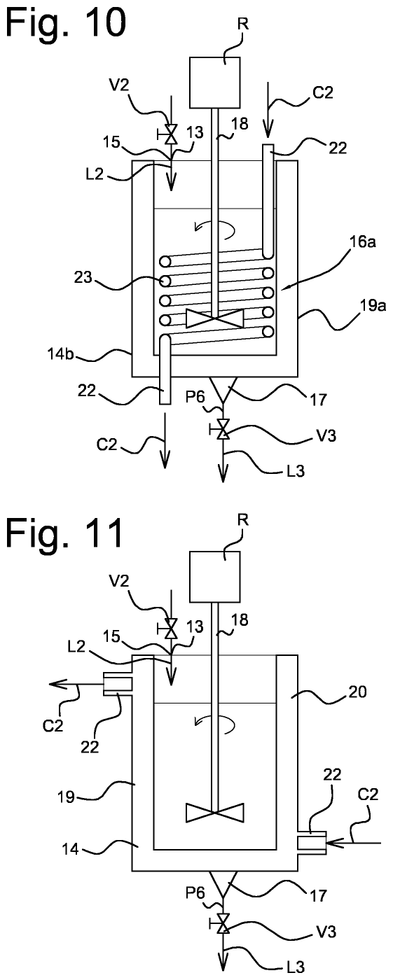

Alternatively or additively, also part of the invention is the cooling assembly 1 according to the invention, wherein the first means 16a for further cooling being a tank 19a comprising a spiral tube 23 in the inner volume of the tank 19a and configured for flowing a second cooling medium c2 through the spiral tube 23 and in fluid connection with a source 21 of the second cooling medium c2 via a tube 22 provided with a driver d, such that insect paste can be produced by cooling pre-cooled insect pulp L2 contained in the first cooling receptacle 14, 14a when the cooling assembly 1 is in operation. See also FIGS. 1 and 10. Spiral tubes 23 for cooling the content of a tank 19a are known in the art, and can beneficially cool such content, especially when such content, e.g. pre-cooled insect pulp, is stirred in the tank 19a.

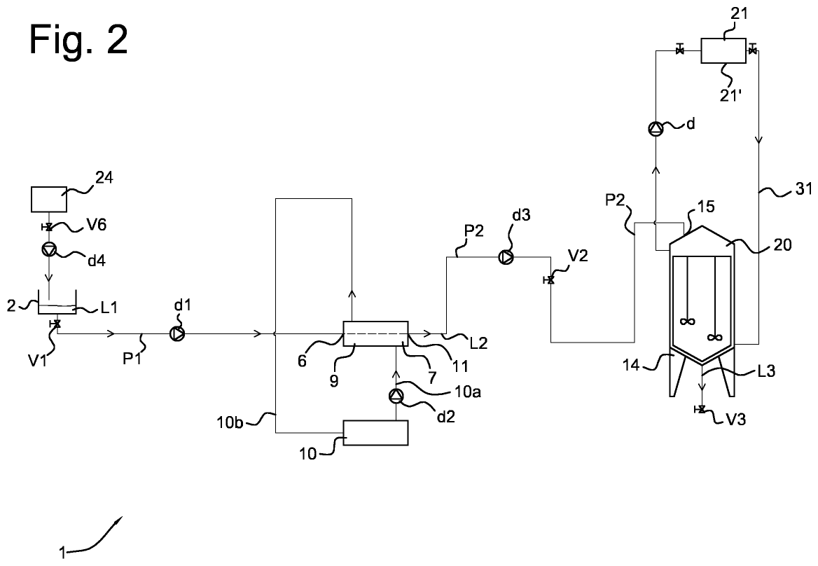

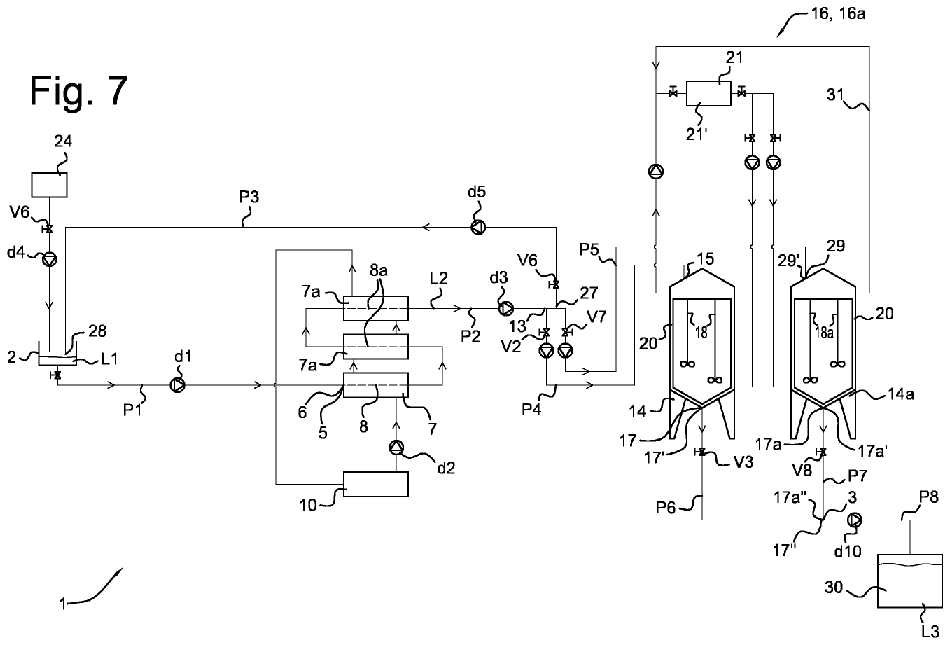

An embodiment is the cooling assembly 1 according to the invention, wherein the first container 2 is in fluid connection with a second container 24 configured to contain heated insect pulp, wherein the second container 24 is optionally configured to heat insect pulp, and wherein the second container 24 is configured to fill the first container 2 with heated insect pulp. The embodiment can be combined with any one or more of the previous embodiments relating to the cooling assembly 1. See also FIGS. 2 and 7. Alternatively, container 2 is (also) configured to heat insect pulp, e.g. minced BSF larvae. Implying such a container 24 allows for fast and efficient feeding of the cooling assembly 1 with heated insect pulp L1, which allows for (semi-)continuous production of insect paste provided when the cooling assembly 1 is applied in the method of the invention for provision of insect paste from heated insect pulp.

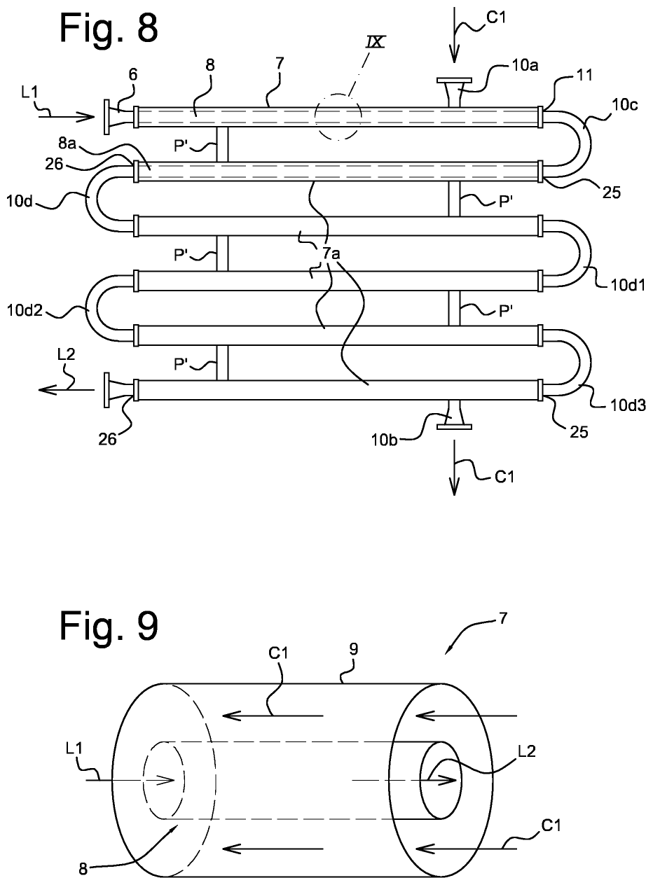

An embodiment is the cooling assembly 1 according to the invention, wherein the cooling assembly 1 comprises a second cooling unit 7a, wherein the downstream end 11 of the inner pipe 8 of the first cooling unit 7 is in fluid connection with the upstream end 25 of an inner pipe 8a of the second cooling unit 7a, and wherein the downstream end 26 of the inner pipe 8a of the second cooling unit 7a is in fluid connection with the upstream end 12 of the second pipe p2,
wherein the second cooling unit 7a is arranged for counter current heat exchange, wherein the inner pipe 8a of the second cooling unit 7a is held concentrically inside an outer pipe 9a of the second cooling unit 7a; wherein the outer pipe 9a of the second cooling unit 7a is in fluid connection with the outer pipe 9 of the first cooling unit 7, the source 10 and the second driver d2; the second driver d2 being further configured for flowing the first cooling medium c1 through the outer pipe 9a of the second cooling unit 7a in opposite direction to insect pulp flowing through the inner pipe 8a of the second cooling unit 7a. The embodiment can be combined with any one or more of the previous embodiments relating to the cooling assembly 1. See also FIGS. 3 and 7-9.

Including one or more further cooling units 7a in the cooling assembly 1 allows for flexible adaptation of the total volume of heated insect pulp which can be cooled within a certain (selected) time period. Typically, for cooling of heated insect pulp at industrial scale, for example batches with a volume of 100 liter or more, the cooling assembly 1 comprises two to ten cooling units 7, 7a, each with a total length of the inner pipes 8, 8a of 3 m-40 m, typically 4 m-20 m. The total inner volume of pipes p1 and p2 and inner pipes 8, 8a of cooling units 7, 7a is typically about the same as the batch volume of heated insect pulp L1 and insect paste L3 provided with the method of the invention, for efficiency reasons. That is to say, when a selected batch volume for the insect paste L3 is determined, the volume of heated insect pulp L1 that can be contained by container 2, the volume of heated insect pulp L1 and pre-cooled insect pulp L2 that can be contained by pipe p1, pipe p2 and the cooling unit(s) 7, 7a, and the volume of pre-cooled insect pulp L2 (equaling the volume of insect paste L3) that can be contained by tank 19, 19a, is about equal to said pre-determined and selected batch volume for insect paste L3. This way, most efficient production of insect paste L3 from heated insect pulp L1 is made possible, where ‘efficient’ relates to the relatively short time of e.g. about 3 minutes, required to cool heated insect pulp from e.g. 90° C. down to 35° C.-45° C., and to the relatively short time of e.g. less than 1 h, required to cool pre-cooled insect pulp from 35° C.-45° C. down to 2° C.-6° C., while the volume of produced insect paste is at an industrially and economically relevant scale of 100 liter per batch or more. In addition, the set-up of the cooling assembly 1 allows for high through-put insect paste batch production, wherein constantly batches of heated insect pulp are fed to pipe p1, cooling unit(s) 7, 7a and pipe p2, at a pace that allows sufficient and complete cooling of the pre-cooled pulp in tank 19, which cooling in tank 19 is the rate limiting step when total pace of production of batches of cool insect paste by applying the cooling assembly 1 is considered, e.g. when the cooling assembly 1 is applied in the method of the invention for large scale production of batches of insect paste at a temperature of e.g. less than 7° C., and with a microbial count that allows application of the insect paste in food industry (for human consumption) and/or in feed industry (e.g. for consumption by pets, livestock, etc.).

An embodiment is the cooling assembly 1 according to the invention, wherein the cooling assembly 1 comprises at least a second cooling unit 7a, such as a second, third, fourth and fifth cooling unit 7a (See FIG. 3, 7, 8), wherein the downstream end 11 of the inner pipe 8 of the first cooling unit 7 is in fluid connection with the upstream end 25 of an inner pipe 8a of the second cooling unit 7a, and wherein the downstream end 26 of the inner pipe 8a of the second cooling unit 7a, or the last cooling unit 7a when a third, fourth, fifth, etc., cooling unit 7a is in serial connection with the first cooling unit 7 and the second cooling unit 7a, is in fluid connection with the upstream end 12 of the second pipe p2, wherein the second, or third, fourth, fifth, etc., if present, cooling unit 7a is arranged for counter current heat exchange, wherein the inner pipe 8a of the second, or the third, fourth, fifth, etc., when present, cooling unit 7a is held concentrically inside an outer pipe 9a of the second, or the third, fourth, fifth, etc., when present, cooling unit 7a; wherein the outer pipe 9a of the second, or the third, fourth, fifth, etc., when present, cooling unit 7a is in fluid connection with the outer pipe 9 of the first cooling unit 7 with the source 10 of a third cooling medium and a fourth driver; the fourth driver being further configured for flowing third cooling medium through the outer pipe 9a of the second, or the third, fourth, fifth, etc., when present, cooling unit 7a in opposite direction to insect pulp flowing through the inner pipe 8a of the second, or the third, fourth, fifth, etc., when present, cooling unit 7a, wherein preferably the third cooling medium is the same as the first cooling medium and wherein preferably the first cooling unit 7 and the second, or the third, fourth, fifth, etc., when present, cooling unit 7a are in fluid connection with the same source 10 of the first cooling medium and the same second driver d2 (here, the fourth driver is the same driver as the second driver d2), such that the source 10, driver d2 and outer pipes 9, 9a are in fluid connection. The embodiment can be combined with any one or more of the previous embodiments relating to the cooling assembly 1.

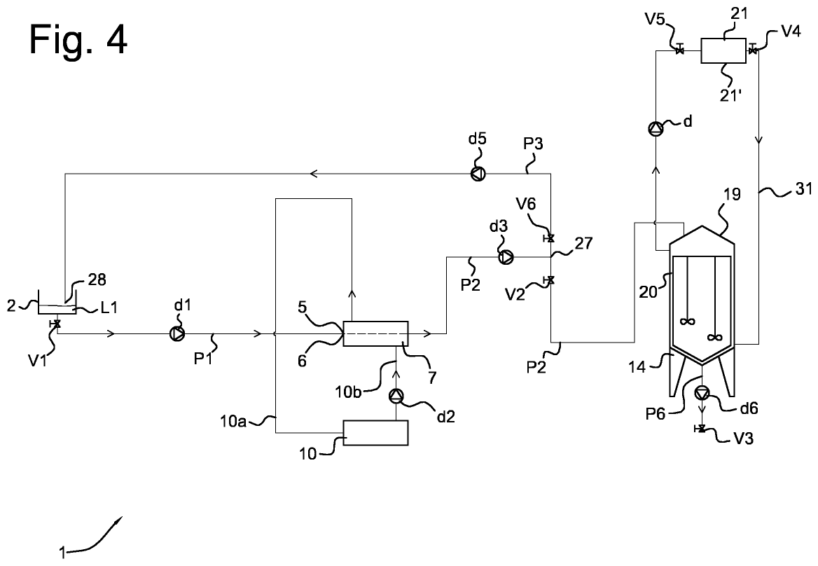

An embodiment is the cooling assembly 1 according to the invention, wherein the second pipe p2 is in fluid connection with the upstream end 27 of a branching third pipe p3 that is provided with a valve v6;
a downstream end 28 of the third pipe p3 being in fluid connection with the first container 2;
the third pipe p3 optionally comprising a fifth driver d5 configured for driving pre-cooled insect pulp from the second pipe p2 to the first container 2. The embodiment can be combined with any one or more of the previous embodiments relating to the cooling assembly 1. See also FIGS. 4 and 7.

Including the pipe p3, optionally comprising driver d5, branching from pipe p2, downstream from the cooling unit(s) 7, 7a, allows for transport of the pre-cooled insect pulp L2 back to container 2. This is beneficial when for example the pre-cooled insect pulp L2 has a higher temperature than 35° C. when exiting the last serially connected cooling unit 7, 7a, and it is aimed for to provide pre-cooled insect pulp L2 at a temperature closer to 35° C. in tank 19, 19a, for further cooling. Presence of the back loop built up by pipe p3 allows for re-circulating the pre-cooled insect pulp L2 through cooling units 7, 7a, until the desired temperature for the pre-cooled insect pulp is achieved.

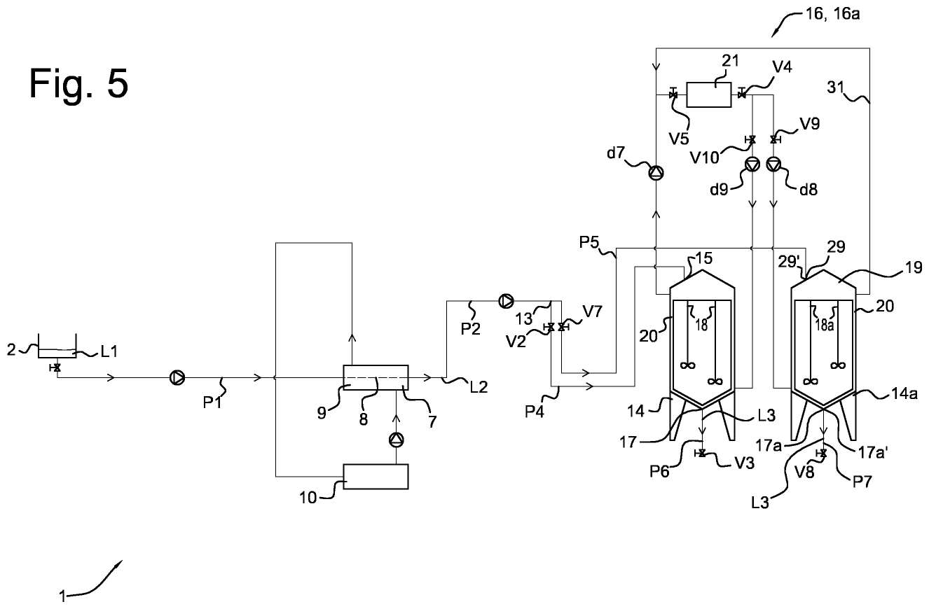

An embodiment is the cooling assembly 1 according to the invention, wherein the downstream end 13 of the second pipe p2 branches into at least a fourth pipe p4 and a fifth pipe p5; the fourth pipe p4 ending in the first cooling receptacle 14; and preferably the downstream end 13 of the second pipe p2 is in fluid connection with the fourth pipe p4 which is in fluid connection with the first inlet 15 of the first cooling receptacle 14;
the fourth pipe p4 being provided with a valve v2;
the fifth pipe p5 ending in a second cooling receptacle 14a, and preferably the downstream end 13 of the second pipe p2 is in fluid connection with the fifth pipe p5 which is in fluid connection with a second inlet 29 of the second cooling receptacle;
the fifth pipe p5 being provided with a valve v7; wherein
the second cooling receptacle 14a is provided with a second means 16, 16a for further cooling pre-cooled insect pulp when present in the second cooling receptacle 14a, and with a means 18, 18a for agitating such as a rotor with blades 18, 18a, a mixer 18, 18a, a stirrer 18, 18a; wherein
the second cooling receptacle 14a is provided with a second outlet 17a configured for discharging insect paste from the second cooling receptacle 14a. The embodiment can be combined with any one or more of the previous embodiments relating to the cooling assembly 1. See also FIGS. 5 and 7.

Including at least a second receptacle 14a in the cooling assembly 1 further improves the flexibility of the assembly when the maximum volume of insect pulp which can be cooled within a certain predetermined time period, is considered. As said, in the method of the invention, the cooling of pre-cooled insect pulp L2 in the tank 19, 19a is the rate limiting step in the method of the invention. Therefore, including the second cooling receptacle 14a increases the rate at which batches of insect paste L3 can be provided with the method of the invention when applying the cooling assembly 1 in the method of the invention. For example, a batch of 400 liter heated insect pulp L1 is cooled into pre-cooled insect pulp L2 in the cooling units 7, 7a, in for example 5 minutes, and released into tank 19, for further cooling under stirring, for, for example, 30 minutes. Immediately thereafter, a new second batch of heated insect pulp is provided or prepared and fed into the cooling units 7, 7a, and subsequently in cooling receptacle 14a. Once the first batch is cooled down to e.g. 2° C.-6° C. in tank 14, tank 14 is emptied e.g. through opening 17 in the bottom of the tank 14, e.g. by pumping, and the first tank 14 is immediately filled with yet a third batch of pre-cooled insect pulp, prepared or provided once the second batch was released into tank 14a. This way, efficiency and turn-over in terms of total volume of insect paste that can be produced per time unit, are increased and flexibility of the cooling assembly 1 is improved.

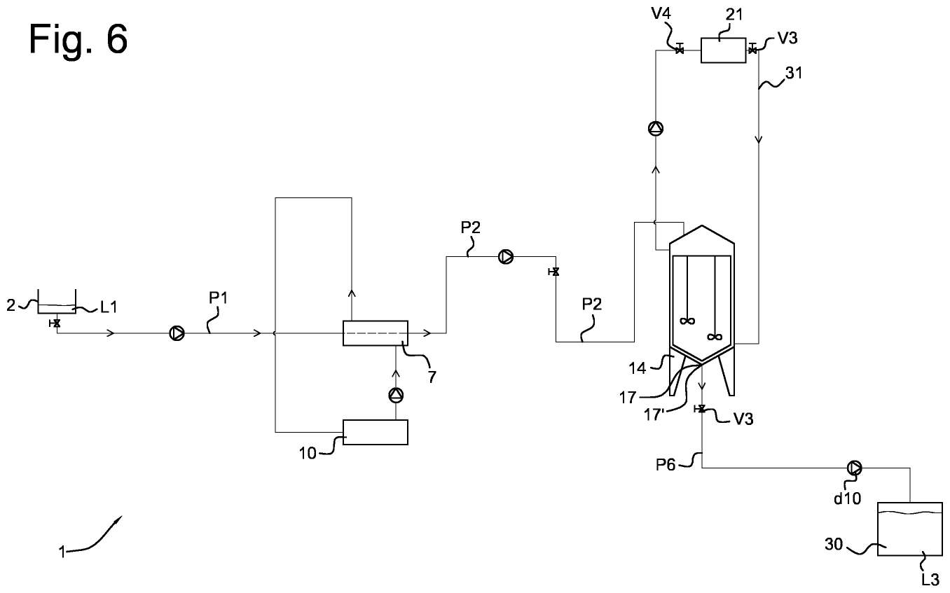

An embodiment is the cooling assembly 1 according to the invention, wherein the first outlet 17 of the first cooling receptacle 14 is in fluid connection with a sixth pipe p6 that is provided with a valve v3, and, if present, a second outlet 17a of the second cooling receptacle 14a is in fluid connection with a seventh pipe p7 that is provided with a valve v8, wherein optionally the sixth pipe p6 and/or the seventh pipe are provided with a driver d6, d10 configured to drive insect paste from the cooling receptacle(s) 14, 14a through the sixth and/or seventh pipe p6, p7. The embodiment can be combined with any one or more of the previous embodiments relating to the cooling assembly 1. See also FIGS. 6 and 7.

An embodiment is the cooling assembly 1 according to the invention, wherein the first outlet 17 of the first cooling receptacle 14 is in fluid connection with the upstream end 17′ of a sixth pipe p6 that is provided with a valve v3, and, if present, a second outlet 17a of the second cooling receptacle 14a is in fluid connection with the upstream end 17a′ of a seventh pipe p7 that is provided with a valve v8, wherein, if the second outlet is present, the downstream end 17″ of the sixth pipe and the downstream end 17a″ of the seventh pipe are in fluid connection with the upstream end 3 of an eighth pipe p8, wherein optionally the eighth pipe p8 is provided with a driver d10 configured to drive insect paste from the first cooling receptacle 14 and through the sixth pipe p6 and, if present, from the second cooling receptacle 14a and through the seventh pipe p7, and subsequently through the eighth pipe p8. The embodiment can be combined with any one or more of the previous embodiments relating to the cooling assembly 1. See also FIG. 7.

An embodiment is the cooling assembly 1 according to the invention, wherein the cooling assembly 1 further comprises
a third container 30 for containing insect paste, that is in fluid connection with the first outlet 17 of the first cooling receptacle 14, and the second outlet 17a of the second cooling receptacle 14a when present, with the sixth pipe p6 and the seventh pipe p7 when present, and with the eighth pipe p8 when present. The embodiment can be combined with any one or more of the previous embodiments relating to the cooling assembly 1. See also FIGS. 6 and 7.

Connecting the cooling receptacle 14 or cooling receptacles 14, 14a of the cooling assembly 1 with pipes p6 and p7, and further with pipe p8 and a further receptacle 30, adds to the efficiency of insect paste production when the cooling assembly 1 is used in the method of the invention. Receptacles 30 are for example suitable for storing and transportation of batches of insect paste at a desired temperature of for example 6° C. or below. Connecting the tanks 14, 14a with pipe 8 comprising a driver d10 and valve(s) v3, v8, allows for timely dosing of a selected volume of insect paste which can be produced by operating the cooling assembly 1.

An embodiment is the cooling assembly 1 according to the invention, wherein the first container 2, and/or the first pipe p1, the first cooling unit 7 and, if present, the at least one second cooling unit 7a and the second pipe p2, and/or the first cooling receptacle 14, 14b or the second cooling receptacle 14a, 14b, and/or the third container 30 has/have a capacity of containing a volume of at least 8 liter, such as 8 liter-20.000 liter, preferably 16 liter-10.000 liter, more preferably 32 liter-5.000 liter, most preferably 64 liter-2.500 liter. The embodiment can be combined with any one or more of the previous embodiments relating to the cooling assembly 1. See also FIG. 1-7.

An embodiment is the cooling assembly 1 according to the invention, wherein the first container 2, and/or the first pipe p1, the one or more of the first cooling unit 7 and, if present, at least one second cooling unit 7a and the second pipe p2, and/or the first cooling receptacle 14, 14b or the second cooling receptacle 14a, 14b, and/or the third container 30 has/have a capacity of containing a volume of at least 64 liter, such as between 64 liter-2.500 liter, preferably a capacity of 128 liter-1.250 liter, more preferably 200 liter-800 liter, most preferably 300 liter-600 liter. The embodiment can be combined with any one or more of the previous embodiments relating to the cooling assembly 1. See also FIG. 1-7.

An embodiment is the cooling assembly 1 according to the invention, wherein the first container 2, and/or the first pipe p1, the one or more of the first cooling unit 7 and, if present, at least one second cooling unit 7a and the second pipe p2, and/or the first cooling receptacle 14, 14b or the second cooling receptacle 14a, 14b, and/or the third container 30 has/have a capacity of containing a mass of at least 10 kg, such as 10 kg-20.000 kg, preferably 20 kg-10.000 kg, more preferably 40 kg-5.000 kg, most preferably 80 kg-2.500 kg. The embodiment can be combined with any one or more of the previous embodiments relating to the cooling assembly 1. See also FIG. 1-7.

An embodiment is the cooling assembly 1 according to the invention, wherein the first container 2, and/or the first pipe p1, the one or more of the first cooling unit 7 and, if present, at least one second cooling unit 7a and the second pipe p2, and/or the first cooling receptacle 14, 14b or the second cooling receptacle 14a, 14b, and/or the third container 30 has/have a capacity of containing a mass of at least 80 kg, such as a capacity of between 80 kg-2.500 kg, preferably a capacity of 120 kg-1.250 kg, more preferably 200 kg-800 kg, most preferably 300 kg-600 kg. The embodiment can be combined with any one or more of the previous embodiments relating to the cooling assembly 1. See also FIG. 1-7.

An embodiment is the cooling assembly 1 according to the invention, wherein the source 10 of the first cooling medium c1 is a tap water work 10. The embodiment can be combined with any one or more of the previous embodiments relating to the cooling assembly 1. See also FIG. 1-7. The cooling units 7, 7a can comprise a closed circuit for circulating cooling liquid c1, such as a tank 10 for holding water c1, optionally a tank 10 provided with a chiller for cooling the circulating water c1. Additively, or alternatively, the cooling assembly 1 can comprise one or more cooling units 7, 7a, wherein the outer pipes 9, 9a are linearly fluidly connected with a source 10 of cooling medium c1 such as water c1, wherein the cooling medium is driven through serially connected outer pipes 9, 9a, and discarded when exiting the last exit of the last outer pipe 9a in the serially connected cooling assemblies 7, 7a (i.e. non-circulating cooling medium c1).

An embodiment is the cooling assembly 1 according to the invention, wherein the means 16, 16a for cooling pre-cooled insect pulp L2 if present in the first cooling receptacle 14 and/or in the second cooling receptacle 14a, when the second cooling receptacle 14a is present, further is provided with a chilling unit 21′ configured to chill the second cooling medium c2 before being driven to the double jacket 20 or the spiral tube 23 of the first cooling receptacle 14 and/or the second cooling receptacle 14a. The embodiment can be combined with any one or more of the previous embodiments relating to the cooling assembly 1. See also FIGS. 1-4 and 7.

An embodiment is the cooling assembly 1 according to the invention, wherein the means 16, 16a for cooling pre-cooled insect pulp L2 if present in the first cooling receptacle 14 and/or in the second cooling receptacle 14a, when the second cooling receptacle 14a is present, is configured as a closed circuit 31 for circulating the second cooling medium c2. The embodiment can be combined with any one or more of the previous embodiments relating to the cooling assembly 1. See also FIG. 1-7. Typically, the means 16, 16a for cooling are suitable for circulating chilled water-glycol mixture for example at a temperature of 0° C. or below such as about −3° C.

Preferred is the method of the invention, wherein the method is applied by using the cooling assembly 1 of the invention, in particular the cooling assembly 1 as outlined in any one of the FIGS. 1-7, more in particular the cooling assembly 1 of FIG. 7. The cooling assembly 1 of the invention is suitable for rapid pre-cooling step (b) of the method without appearance of clogging insect pulp within the pipes p1, p2 and inner pipes 8, 8a of the cooling assembly 1, and for rapid cooling step (c) of the method, without introducing clogging of insect pulp or paste in the cooling receptacle 14, 14a. Therefore, an embodiment is the method of the invention, wherein method step (b) and/or method step (c) is/are performed using the cooling assembly 1 of the invention, preferably both method step (b) and method step (c) are performed using the cooling assembly 1 of the invention. The embodiment can be combined with any one or more of the previous embodiments relating to the method of the invention and/or the embodiment can be combined with any one or more of the previous embodiments relating to the cooling assembly 1 of the invention, in particular the embodiment relating to the cooling assembly 1 of FIG. 7. See also FIG. 1-12.

Heat treating food could be used to enhance food palatability, improve sensory quality, increase shelf-life or destroy pathogenic microorganisms. Heating food results in chemical changes, which could be desirable, such as the ones rendering to the food characteristic mentioned above but others are undesirables, such as nutritional losses. Some examples of chemical changes that can be induced in heat processed food are: altered water holding capacity (WHC), altered protein dispersibility index (PDI), and also for example protein hydrolytic decomposition (hydrolysis of proteins), oxidative rancidity, protein denaturation, color degradation, enzymatic degradation, caramelization of carbohydrates, interactions between proteins and organic molecules, etc. When selecting which heat treatment to apply to a certain food, it is important to take into consideration which characteristics are wanted to be induced in the final product and what the intrinsic food characteristics are (e.g. WHC, PDI, food matrix, microbial load, etc.). Some examples of heat treatment used in food processing are pasteurization, sterilization, canning or blanching.

The major food components are water, carbohydrates (sugar and starch), proteins and fats. The effect of heating sugar can induce changes in color or flavor by the caramelization process. Additionally, sugar and amino acids when exposed to high temperature may undergo Maillard reaction that results in by-products that change the color (browning), flavor or aroma of food. In order for these reaction to be initiated, temperatures should be elevated. Protein functionality may be affected by Maillard reactions but also protein solubility and other technical properties (e.g. textural or foaming properties). Additionally, Maillard reaction may also lower protein digestibility as suggested by in vitro and in vivo studies. The effects of Maillard products for the health of the consuming animal or person is currently not clear. In some cases, products of Maillard reaction have been linked to promoting inflammation while in other cases, they have been suggested to have anti-oxidant effect. In general, Maillard reaction to a certain extent is desirable to improve food or feed properties, although excessive presence of products from Maillard reaction, which may be linked to darker food colour, is undesirable due to their potentially unwanted health effects. The heating process occurring in starch and water results in gelatinization, which is the process by which starch granules absorb water and swell causing the liquid to thicken. Gelatinization takes places at different temperatures for the different starches. In proteins, the heating process results in changes in solubility and structural properties of the proteins associated with protein denaturalization and unfolding. The intensity of these changes is associated with the conditions of the heating treatment (time, temperature, etc.). Fats usually melt while heating at temperatures of 37° C. to 40° C. Further heating may result in fat degradation and formation of free fatty acids. If heating at high temperatures continues, it may lead to fat oxidation. Some of the most common effects of heating in e.g. meat are: fat melting and protein unfolding (temperature 30-40° C.), carbohydrates gelatinization (40-45° C.) and initiation of water losses (up to 46° C.).

Lipids are key components that provide to the body compounds that can only be introduced via diet such as essential fatty acids or soluble vitamins. In addition, lipids are key e.g. to provide the desirable meat characteristics that consumers highly appreciate such as flavor and contributor of meat tenderness and juiciness. For this reason, it is of paramount important to prevent fat oxidation in order to keep the desirable meat characteristic.

Insects are processed for the purpose of producing insect ‘meal’. Such insect meal is for example obtained by the steps of i) particulization of e.g. insect larvae; ii) processing steps such as enzymatic treatment and mixing and heating; and iii) a separation step for obtaining the meal. Such meal, e.g. black soldier fly larvae meal, typically comprises 3%-20% by weight lipids (fats), based on the dry weight of the meal. Alternatively, insects are processed for the purpose of producing insect paste. Such insect paste is for example obtained by the steps of i) particulization of e.g. insect larvae; ii) processing steps, such as enzymatic treatment and mixing and heating; and iii) a cooling step for obtaining the paste. Such paste, e.g. black soldier fly larvae paste, typically comprises 15%-40% by weight lipids (fats), based on the dry weight of the paste. Based on the similarities between such an insect meal or such an insect (larvae) paste, and meat, it is assumed that the oxidation process taking place in meat products, occurs analogues to the oxidation process of insect paste or insect meal.

In short, lipids oxidation is initiated when unsaturated fatty acids react with molecular oxygen via a free radical mechanism. As a result of this reaction, the first products of lipid oxidation form, which are hydroperoxides which are odorless and do not contribute to aroma. These compounds are highly unstable and they will form secondary products of oxidation such as hydrocarbons, aldehydes or ketones, which are the compounds responsible for the off-flavour and off-odours in meat, being aldehydes (correlated with p-anisidine value) the larger contributor to volatile product in meat. Additionally, aldehydes can react with proteins and consequently, altering the nutritional and organoleptic properties of the product.

Both intrinsic and extrinsic factors play a role in the fat oxidation process, and the oxidative stability depends on the balance between such components. Regarding the intrinsic factors, fatty acid composition is the main factor followed by the presence of haem-proteins, metals (cations), pro- and anti-oxidant compounds. In the other hand, it is known that extrinsic parameters such as exposure to light, oxygen and temperature increases the fat oxidation process.

Based on the nutritional similarities and the sustainable benefits, insects are being used as alternative to meat. Meat and meat products are specially relevant since these are rich in nutritional components such as minerals, vitamins, proteins, carbohydrates, fats and other bioactive compounds.

Due to the novelty of insects and products derived therefrom as a new food source, many of the processing methods concerning insects and such products are under development to ensure a good quality product. In some cases, due to the use of insects as ingredients, they are further processed before obtaining the final product. This is particular relevant in pet food and in food products for human consumption, for which ingredients are usually extensively heat-processed to increase the shelf-life, to achieve a desirable physical form or to increase palatability. This further heat processing may compromise the quality of the end product, e.g. the processed whole insects such as insect paste, or products derived from (processed) whole insects, such as protein meal, fats and lipids, etc. Moreover, when introducing a novel feed or feed ingredient for animal nutrition or a novel food or food ingredient for human nutrition, such as pet nutrition or human food stuff, it is of interest to evaluate digestibility of such a food.

Additionally, heating also plays a relevant role in the safety of the processed insect or of a product derived from insects, from the microbiological point of view, and achieving a low microbial burden helps increasing the shelf-life. Commonly, applying a pasteurization process comprises mild heat treatment aiming to destroy most (99%) of microbes. Moreover, microbiological markers such as Total Plate Count (TPC) or Enterobacteriaceae are used as hygiene indicators of the Good Manufacturing Process (GMP) and Hazard Analysis and Critical Control Points (HACCP) system of the company in place.

By applying the method of the invention, and in particular by applying the method of the invention using the cooling assembly 1 of the invention, the inventors surprisingly found that insect paste with unique features is obtained, not seen with insect paste provided with methods known in the art. As said before, due to the relatively fast cooling from about 90° C. down to about 2° C.-6° C. in e.g. less than 1 hour, insect paste can be provided which has unique features relating to the combination of a sufficiently low microbial load, a relatively light color (as further outlined in the Examples section), a relatively high water holding capacity, and/or a relatively high PDI. When heated insect paste is applied in the method of the invention, which was pasteurized at 85° C.-100° C. for 10 minutes or less, such as 90° C.±3° C. for 75 seconds-7 minutes, or about 80 seconds, about 160 seconds or about 5 minutes, at 90° C.±2° C., preferably using the cooling assembly 1 of the invention, in particular the cooling assembly 1 according to any of FIGS. 1-7, insect paste is provided which has a low microbial count, i.e. less than 10 cfu/g Enterobacteriaceae and an aerobic mesophilic plate count of lower than 6×10E6, preferably lower than 5×10E6, more preferably lower than 4×10E6, which has a high WHC of 90% or higher, and/or which has a PDI of larger than 40%, and/or which has a relatively light color.

An aspect of the invention is an insect paste with a water holding capacity (WHC) of 90% or higher, preferably 90.5% or higher, more preferably 91% or higher, most preferably 92% or higher, such as 92.5% or higher or 93.5% or higher, based on the total weight of the insect paste, preferably in the range of 90% by weight-98% by weight, wherein the WHC is expressed as 100% minus the weight percentage of water that is released from the insect paste during a heating step subjected to the insect paste at a temperature of 121° C. for 80 minutes, based on the total weight of the insect paste before being subjected to this heating step. The heating step is performed with the sample contained in a closed container (air tight).

In particular, part of the invention is an insect paste, wherein the insect paste has a water holding capacity (WHC) in the range 91% by weight-97% by weight, based on the total weight of the insect paste, wherein the WHC is expressed as 100% minus the weight percentage of water that is released from the insect paste during a heating step subjected to the insect paste at a temperature of 121° C. for 80 minutes, based on the total weight of the insect paste before being subjected to this heating step, preferably higher than 92% by weight or 92% by weight-96% by weight, more preferably 92.5% by weight-95.5% by weight, most preferably 93% by weight-97% by weight, such as 94% by weight±2% by weight or 94% by weight±3% by weight. The embodiment can be combined with any one or more of the previous embodiments relating to the insect paste of the invention, and/or relating to the method of the invention and/or the embodiment can be combined with any one or more of the previous embodiments relating to the cooling assembly 1 of the invention.

Such insect paste of the invention typically has a protein dispersibility index (PDI) of at least 42% by weight based on the total weight of the insect paste, wherein the protein dispersibility index is determined according to AOCS Standard Procedure Ba 10-09 2017 and wherein, in accordance with the AOCS Standard Procedure Ba 10-09 2017, protein content is determined with the Dumas method in accordance with NEN-EN-ISO 16634, such as a PDI of 42-56% by weight, preferably at least 43% by weight or 43-54% by weight, more preferably at least 44% by weight, or 44-52% by weight, most preferably at least 45% by weight, or 45-50% by weight. The embodiment can be combined with any one or more of the previous embodiments relating to the insect paste of the invention, and/or relating to the method of the invention and/or the embodiment can be combined with any one or more of the previous embodiments relating to the cooling assembly 1 of the invention.

Preferred is the insect paste of the invention, wherein at least 55% surface area of the insect paste has a color pattern comprising any one or more of hexadecimal color codes (Hex triplets) selected from the range of Hex triplets encompassed by thirteen color code areas that are each defined by at least a single color code and a set of four color code limits and straight lines between these color code limits, in the order top-left to top-right to bottom-right to bottom-left to top-left (single color code(s) in each defined color code area in brackets):
#d6bcb4-#dba697-#875546-#73554d (#ba978d);
#a68f88-#ad8072-#704b40-#6b5c58 (#82635a);
#ad8d84-#b58274-#6e4d44-#755b54 (#6e4d44);
#ccb7b1-#cfa69b-#8f655a-#856d67 (#bfa49d);
#c7a69f-#c78d81-#734a41-#6e5651 (#8c6a63);
#a6887c-#a3664e-#754836-#76574b (#6e5046);
#d9ad9c-#d47b59-#6b4333-#705d55 (#76574b);
#b5988d-#b88672-#7d5748-#8a6c60 (#906f62);
#c7a497-#c28772-#85503d-#966f61 (#966f61);
#c9afab-#d69992-#b69692-#82716f (#876560, #a78a85, #b69692, #bd9d99, #c9a9a3, #bc9c96);
#d6a987-#db9158-#945525-#8a674c (#a8744c);
#c2a491-#c47e52-#8a512d-#876f60 (#a98670); and
#d6a476-#c9803e-#855122-#946c48 (#ae7038),
   preferably at least 58%, more preferably at least 63%, most preferably at least 70%, such as 56-93%, 57-88% or 59-85%. The embodiment can be combined with any one or more of the previous embodiments relating to the insect paste of the invention, and/or relating to the method of the invention and/or the embodiment can be combined with any one or more of the previous embodiments relating to the cooling assembly 1 of the invention. For example, Samples 1A, 2A and 3A (see the Examples section, here below) fulfil this color requirement, providing a relatively light grey/light brown insect paste with a wet look at the surface and a porridge-like appearance. The insect paste provided with the method of the invention, for example, especially when provided when applying process steps (i)-(iii) in step (a) of the method, wherein the pasteurization time (heating time) for the minced BSF larvae is between 70 seconds and 300 seconds or less than 300 seconds, such as 75 seconds-260 seconds, at 90° C., has such a color pattern when cooled according to step (b) of the method, in about 3 minutes, and when subsequently cooled according to step (c) of the method in about 30 minutes to 2.5 hours such as 1-2 hours. The WHC is higher than 90%, and for relatively short pasteurization times of 80 seconds or 160 seconds in step (a) of the method, even above 91%. The protein dispersibility index accompanying the indicated major color of the insect paste, is higher than 42% for insect paste that was heated for 80 seconds at 90° C. in step (a), cooled to 35° C. in about 3 minutes in step (b), and cooled to about 3° C.-6° C. in step (c) in about 1 hour-2 hours.

Preferred is the insect paste of the invention, wherein at least 70% surface area of the insect paste has a color pattern comprising any one or more of hexadecimal color codes (Hex triplets) selected from the range of Hex triplets encompassed by thirteen color code areas that are each defined by at least a single color code and a set of four color code limits and straight lines between these color code limits, in the order top-left to top-right to bottom-right to bottom-left to top-left (single color code(s) in each defined color code area in brackets):
#d6bcb4-#dba697-#875546-#73554d (#ba978d);
#a68f88-#ad8072-#704b40-#6b5c58 (#82635a);
#ad8d84-#b58274-#6e4d44-#755b54 (#6e4d44);
#ccb7b1-#cfa69b-#8f655a-#856d67 (#bfa49d);
#c7a69f-#c78d81-#734a41-#6e5651 (#8c6a63);
#a6887c-#a3664e-#754836-#76574b (#6e5046);
#d9ad9c-#d47b59-#6b4333-#705d55 (#76574b);
#b5988d-#b88672-#7d5748-#8a6c60 (#906f62);
#c7a497-#c28772-#85503d-#966f61 (#966f61);
#c9afab-#d69992-#b69692-#82716f (#876560, #a78a85, #b69692, #bd9d99, #c9a9a3, #bc9c96);
#d6a987-#db9158-#945525-#8a674c (#a8744c);
#c2a491-#c47e52-#8a512d-#876f60 (#a98670); and
#d6a476-#c9803e-#855122-#946c48 (#ae7038),
   preferably at least 72%, more preferably at least 75%, most preferably at least 80%, such as 70-93%, 73-88% or 77-85%. The embodiment can be combined with any one or more of the previous embodiments relating to the insect paste of the invention, and/or relating to the method of the invention and/or the embodiment can be combined with any one or more of the previous embodiments relating to the cooling assembly 1 of the invention. For example, Sample 1A (see the Examples section, here below) fulfils this color requirement, providing a relatively light grey/light brown insect paste with a wet look at the surface and a porridge-like appearance. The insect paste provided with the method of the invention, for example, especially when provided when applying process steps (i)-(iii) in step (a) of the method, wherein the pasteurization time (heating time) for the minced BSF larvae is about 80 seconds, at 90° C., has such a color pattern when cooled according to step (b) of the method, in about 3 minutes, and when subsequently cooled according to step (c) of the method in about 30 minutes to 2 hours such as 45 minutes-90 minutes. The WHC is higher than 92%, and for relatively short pasteurization times of 80 seconds in step (a) of the method, even above 93%. The protein dispersibility index accompanying the indicated major color of the insect paste, is higher than 42% for insect paste that was heated for 80 seconds at 90° C. in step (a), cooled to 35° C. in about 3 minutes in step (b), and cooled to about 3° C.-6° C. in step (c) in about 2 hours or even 30 minutes-90 minutes.

According to certain embodiments, the insect paste of the invention, that is provided with the method of the invention wherein in step (a) of the method the provided heated insect pulp is insect pulp obtained by the process steps of:
(i) providing insects, preferably insects that are washed, preferably washed with water;
(ii) preparing a pulp from the insects of process step (i); and
(iii) heating the insect pulp of process step (ii) for 50-200 seconds, preferably for 65-170 seconds, at a temperature of 60° C.-100° C., preferably 85° C.-98° C., and optionally subsequently cooling to a temperature of 45° C.-99.5° C., optionally 60° C.-99.5° C., therewith providing the heated insect pulp of step (a) of the method,
   has a color pattern of which at least 70% of the colors in the color pattern has a hexadecimal color code (Hex triplet) selected from the range of Hex triplets: #6e472a, #6e4d44, #6e5046, #705a59, #71574e, #76574b, #765847, #76646b, #785744, #785c50, #78605e, #79646a, #796775, #7a6360, #7a676b, #7c6972, #7e6768, #816765, #816d75, #82635a, #826c6b, #866861, #876560, #877071, #877073, #896345, #8b7172, #8b7270, #8c6a63, #8e6e68, #8f7469, #906f62, #917b83, #935f39, #937879, #937978, #947b7b, #966f61, #977e80, #988288, #997b7b, #9a7761, #9b7144, #9b96b4, #9d7f74, #9d98b2, #9e8377, #a1837d, #a2816d, #a28c8f, #a38e97, #a38f97, #a78a85, #a8744c, #a98670, #ae7038, #af9288, #b49fa9, #b69692, #b9967b, #ba978d, #bc9c96, #bd9d99, #bea2a0, #bfa49d, #c9a9a3, #caaea6, #cbafab, #d5c8cf, #dabdba, #daccd6, #dcc5b7, preferably at least 72%, more preferably at least 75%, most preferably at least 80%, such as 70-93%, 73-88% or 77-85%.

Typically, such insect paste of the invention has a WHC of 90% or higher, preferably 91% or higher, based on the total weight of the insect paste, preferably in the range of 90% by weight-98% by weight, wherein the WHC is expressed as 100% minus the weight percentage of water that is released from the insect paste during a heating step subjected to the insect paste at a temperature of 121° C. for 80 minutes, based on the total weight of the insect paste before being subjected to this heating step. Typically, such insect paste of the invention has a protein dispersibility index (PDI) of at least 42% by weight based on the total weight of the insect paste, wherein the protein dispersibility index is determined according to AOCS Standard Procedure Ba 10-09 2017 and wherein, in accordance with the AOCS Standard Procedure Ba 10-09 2017, protein content is determined with the Dumas method in accordance with NEN-EN-ISO 16634, such as a PDI of 42-56% by weight, preferably at least 43% by weight or 43-54% by weight, more preferably at least 44% by weight, or 44-52% by weight, most preferably at least 45% by weight, or 45-50% by weight.

In particular, the insect paste of the invention, that is provided with the method of the invention wherein in step (a) of the method the provided heated insect pulp is insect pulp obtained by the process steps of:
(i) providing insects, preferably insects that are washed, preferably washed with water;
(ii) preparing a pulp from the insects of process step (i); and
(iii) heating the insect pulp of process step (ii) for 50-200 seconds, preferably for 65-120 seconds, more preferably 70-100 seconds, at a temperature of 60° C.-100° C., preferably 85° C.-98° C., and optionally subsequently cooling to a temperature of 45° C.-99.5° C., optionally 60° C.-99.5° C., therewith providing the heated insect pulp of step (a) of the method,
   has a color pattern of which at least 55% of the colors in the color pattern has a hexadecimal color code (Hex triplet) selected from the range of Hex triplets: #6e472a, #6e4d44, #6e5046, #705a59, #71574e, #76574b, #765847, #76646b, #785744, #785c50, #78605e, #79646a, #796775, #7a6360, #7a676b, #7c6972, #7e6768, #816765, #816d75, #82635a, #826c6b, #866861, #876560, #877071, #877073, #896345, #8b7172, #8b7270, #8c6a63, #8e6e68, #8f7469, #906f62, #917b83, #935f39, #937879, #937978, #947b7b, #966f61, #977e80, #988288, #997b7b, #9a7761, #9b7144, #9b96b4, #9d7f74, #9d98b2, #9e8377, #a1837d, #a2816d, #a28c8f, #a38e97, #a38f97, #a78a85, #a8744c, #a98670, #ae7038, #af9288, #b49fa9, #b69692, #b9967b, #ba978d, #bc9c96, #bd9d99, #bea2a0, #bfa49d, #c9a9a3, #caaea6, #cbafab, #d5c8cf, #dabdba, #daccd6, #dcc5b7, preferably at least 63%, more preferably at least 66%, most preferably at least 70%, such as 60-93%, 70-88% or 72-85%, and has a water holding capacity of 90% or higher, preferably 91% or higher, based on the total weight of the insect paste, preferably in the range of 90% by weight-98% by weight, wherein the WHC is expressed as the weight percentage of water that is released from the insect paste during a heating step subjected to the insect paste at a temperature of 121° C. for 80 minutes, based on the total weight of the insect paste before being subjected to this heating step.

A preferred embodiment is the insect paste of the invention, obtained with the method according to any one of the previous embodiments relating to the method of the invention, in so far the method comprises in step (a) the process steps (i)-(iii), or an embodiment is the insect paste of the invention, obtainable by the method according to the invention in so far the method comprises in step (a) the process steps (i)-(iii). That is to say, part of the invention is the insect paste obtainable with the method of the invention or the insect paste obtained with the method of the invention, wherein in process step (iii) of step (a) of the method, the insect pulp of process step (ii) is heated for 10 minutes or less, preferably for 8 minutes or less, more preferably for 6 minutes or less, most preferably for 5 minutes or less, such as 70 seconds-10 minutes, 70 seconds-5 minutes or 75 seconds-200 seconds, at a temperature of 80° C.-100° C., preferably 85° C.-95° C., more preferably 90° C.±3° C., most preferably 90° C.±2° C., therewith providing the heated insect pulp of step (a) of the method. The embodiments can be combined with any one or more of the previous embodiments relating to the insect paste of the invention. Typically, the insect paste of the invention is provided by applying the method of the invention, and typically, by using the cooling assembly of the invention in the method of the invention. Preferably, the insect paste is produced from heated minced BSF larvae, typically at an age of 9-15 days, such as about 14 days or 10-12 days of age, post hatching. The embodiment can be combined with any one or more of the previous embodiments relating to the insect paste of the invention, and/or relating to the method of the invention and/or the embodiment can be combined with any one or more of the previous embodiments relating to the cooling assembly 1 of the invention.

The inventors established that the method of the invention is particularly suitable for providing insect paste based on heated BSF larvae pulp. The inventors also established that the cooling assembly 1 of the invention is particularly suitably for application in the method of the invention, and for providing insect paste based on heated BSF larvae pulp, as obtainable with the method of the invention. Therefore, preferred insect paste is insect paste of the invention, wherein the insect is black soldier fly larvae, wherein preferably said larvae are 6 days-30 days of age, preferably 8 days-28 days of age, more preferably 9-26 days of age, most preferably 10-24 days of age, most preferably 10-15 days of age, and/or wherein preferably said larvae are at an age 12 hours-3 days before the larvae transform into prepupae, such as 1-2 days before said transformation, and more preferably, the insect paste is derived from black soldier fly larvae that are 6-20 days of age or that are at an age 12 hours-3 days before the black soldier fly larvae transform into prepupae.

An aspect of the invention relates to a food product, food ingredient, feed product or feed ingredient comprising the insect paste of the invention or comprising the insect paste obtained with the method according to the invention.

The insect paste according to the invention has a relatively high WHC of 90% or higher. Such a high WHC for the insect paste (BSF larvae paste) provided with the method of the invention or obtainable with the method of the invention, e.g. by applying the cooling assembly of the invention, is for example beneficial when the insect paste is applied as feed or as a feed ingredient in animal feed applications. For example, the insect paste is applied as a meat replacer or as a partial meat replacer in animal feed such as cat or dog feed. It is commonly known that a meat replacer with a relatively high WHC (minimal water loss), such as the insect paste of the invention and for example as provided by the method of the invention, is preferred for feed applications compared to a further product with a lower WHC (higher water loss when put under heat stress), such as the insect paste obtainable with conventional methods known in the art. The same or similar considerations apply for the use of the insect paste of the invention and for example provided with the method of the invention, when food applications for human use are considered. Water holding capacity is understood as the ability of food to hold its own or added water during the application of a force, pressure, centrifugation or heating. A higher WHC (less water loss), that is to say, an improved WHC, is for example related to products consisting of or comprising the insect paste of the invention, which have better processing yields, better cooking yields, more juiciness and tenderness (product texture) of the product consisting of or comprising the meat replacer, or less loss of valuable water-soluble nutritional compounds (e.g. water soluble vitamins) i.e. at least partially the insect paste according to the invention, a better protein functionality, an improved color (less pale lean color), firmer structure, less purge in the shelved product, less drip loss from the product consisting of or comprising the insect paste of the invention, compared to products consisting of or comprising insect paste obtained with a conventional method known in the art, e.g. a method combining a relatively long pasteurization time of 5 minutes or more (e.g. 30 minutes) for provision of heated insect pulp, with a relatively long-lasting period of cooling the heated insect pulp to e.g. ambient temperature or below, for providing the insect paste.

The insect paste of the invention has an improved PDI, i.e. a PDI of at least 40%, e.g. in combination with a high WHC of 90% or higher such as 92% or higher, and/or in combination with a relatively light color. Protein Dispersibility Index measures the percentage of protein that solubilizes in distilled water under the test conditions in comparison to the total amount of protein in the sample. Heating and subsequent relatively slow cooling of insect pulp according to conventional methods for providing insect pulp known in the art, can cause protein denaturation, which can result in protein aggregation, which may be at the basis of the improved PDI seen for the insect paste of the invention: relatively short pasteurization time combined with a relatively short period of time within which the heated insect pulp is cooled and insect paste is provided. Protein aggregation may be favoured by relatively long pasteurization and/or by prolonged cooling time, which may affect protein dispersibility. Depending on the degree of protein aggregation (dependent on the amino acid composition, etc.), protein aggregates may be more or less soluble. Protein solubility, i.e. protein dispersibility, is commonly defined as “proportion of nitrogen in a protein product which is in the soluble state under certain conditions”. Protein solubility is key in liquid food (e.g. wet pet food) and beverages. In general, higher protein solubility (correlated with higher PDI) is preferable for food and feed application from the technical point of view. if proteins are highly soluble, they would have good dispersibility of protein molecules and result in formation of finely dispersed colloidal systems, which have a more homogenous-like appearance making them more appealing. Additionally, high protein solubility widens the food and feed applications in which they can be used, making them preferable in the food and feed industry

Proteins solubility depends on amino acid composition and sequence, its molecular weight, conformation or content of polar and non-polar groups in amino acids. There are many factors that affect protein solubility such as pH, temperature or processing conditions. In the case of heating and subsequent slow cooling of heated insect pulp, it affects protein solubility negatively by inducing changes in its conformation that are suggested to reduce its solubility. On average, a combination of high temperatures (90° C. or higher) for prolonged time (>10 minutes such as 30 minutes) results in decrease of protein solubility. Protein solubility is commonly used as indicator of the degree of protein denaturation during processing and can be used to control emulsification, foaming, extraction and gelation processes. Also, protein solubility can be used as indicator to optimize the processing conditions.

The relatively light color of the insect paste of the invention, e.g. provided by the method of the invention, e.g. when using the cooling assembly of the invention, is indicative for relatively less occurrence of protein aggregates and denatured protein, relatively less formation of brown Maillard products due to glycation of proteins, compared to protein aggregation and or formation of Maillard products with insect paste obtained from heated insect pulp that was heated for longer than 10 minutes such as for 30 minutes, and/or insect paste obtained by relatively slowly cooling heated insect pulp to ambient temperature or below by leaving heated insect pulp at ambient temperature for prolonged time while standing still, e.g. unstirred, not under flow. For application in food or feed or as an ingredient in food or feed stuff, insect paste with less protein aggregates, less denatured protein and/or less Maillard products is desired. The insect paste of the invention has a relatively light color compared to darker insect paste relating to more protein aggregation and/or more formation of Maillard products with insect paste obtained from heated insect pulp that was heated for longer than 10 minutes such as for 30 minutes, and/or insect paste obtained by relatively slowly cooling heated insect pulp to ambient temperature or below by leaving heated insect pulp at ambient temperature for prolonged time while standing still, e.g. unstirred, not under flow. Such light insect paste of the invention has a more fresh appearance and is more appealing to the consumer (human, animal, e.g. pet, livestock). Additionally, lighter color may be associated with presence of a lower degree of Maillard reaction products, which would be beneficial for the consuming animal or person as some of these Maillard products may have undesirable health effects (e.g. promoting inflammation).

The invention is further illustrated by the following examples, which should not be interpreted as limiting the present invention in any way.

### Examples

### Raw Material

Live and washed larvae (black soldier fly) of 10-12 days old post hatching were used as starting point for different treatments, i.e. applying the fast cooling method of the invention and applying a conventional long-lasting cooling method according to common practice at Protix (NL).

### Chemicals

All the chemicals were analytical grade. All the test were performed in an accredited laboratory with the exception of the water holding capacity test.

### Methods

### Sample Generation

Heated insect pulp provided in method step (a) was provided using the conventional method according to WO2014123420 or using a new method developed by Protix (NL), wherein in process step (iii) of method step (a) the pulp was heated for 80 seconds, 160 seconds, 5 minutes, or 30 minutes at 90° C., before being subjected to the subsequent cooling step under flow (method step (b)) and cooling step (method step (c)) under stirring. Batches of heated insect puree provided in method step (a) were typically at a temperature of 80° C.-100° C., such as 85° C.-95° C., before being subjected to method step (b).

Eleven heated BSF larvae puree samples were prepared, of which nine are prepared according to Table 1.

Each sample of Table 1 was prepared at least in duplicates (n=2 for sample D, n=4 for all other samples). To generate the samples 1A, 1 B, 2A, 2B, 3A, 3B, 4A and 4B, a laboratory-scale simulation of the processing conditions was performed that mimics the time scale for cooling heated insect pulp at industrial large scale (e.g. batches of 400 liter). That is to say, the pre-cooling during step (b) of the method, here applied at lab scale and at industrial scale, for both type of samples (lab scale (several tens to several hundreds of grams) and industrial scale (tens to hundreds of liter)) takes about the same time, independent of the scale. The similar applies to the cooling time in method step (c): the smaller-size pre-cooled insect pulp samples at lab scale and the large-scale industrial batches are cooled to 3° C.-6° C. in about the same time frame. This way, small-scale and large-scale samples are comparable and features and characteristics assessed for either a small-scale sample, or a large-scale sample, serves as a representative for the insect paste provided either at large scale or at small scale, independent of the scale (volume, mass) at which the insect paste was produced with the method of the invention. Sample D was produced at the large-scale industrial scale facilities of Protix (Dongen, The Netherlands), in Q1-2021. The batch of BSF paste referred to as Sample D was at 400-liter scale. The batches of sample D were prepared with minced BSF larvae 10-14 days of age, which were pasteurized by heating for 80 seconds at 90° C. This heated insect pulp was left at ambient temperature for 2 hours till the temperature was about 70° C. Then, the insect pulp was kept at 4° C. for 3-16 hours, and optionally frozen at −20° C. thereafter. For the tests (water holding capacity expressed as water loss, protein dispersibility index, color, microbial load), a sample D of 400 liter was applied that was first at 90° C., then cooled to about 70° C. without stirring and in steady state (not under flow), followed by further cooling to 4° C. while unstirred and not flowing, followed by further cooling to −20° C. while unstirred and not flowing, which took from the start at 90° C. to the frozen state about 24 h.

TABLE 1
Sample preparation for BSF paste

| | Pasteurization method | |
|---|---|---|
| | (pasteurization time) | |
| Sample # | [step (a) of the method] | Cooling method |
| 1-A | 1 (80 seconds) | A (method of the invention) |
| 1-B | 1 (80 seconds) | B (conventional method) |
| D | 1 (80 seconds) | B |
| 2-A | 2 (160 seconds) | A |
| 2-B | 2 (160 seconds) | B |
| 3-A | 3 (5 minutes) | A |
| 3-B | 3 (5 minutes) | B |
| 4-A | 4 (30 minutes) | A |
| 4-B | 4 (30 minutes) | B |

Cooling method
A. steps (b) and (c) of the method of the invention: temperature drop from 90° C. to 35° C. in 3 minutes in step (b) of the method, then, drop in temperature from 35° C. to 4° C. in 120 minutes (step (c) of the method) (then optional freezing step to −20° C.)).
B. conventional method of cooling: temperature drop from 90° C. to 70° C. in 2 hours followed by a long-lasting and relatively slow cooling step by leaving the batch of larvae puree at ambient temperature such as room temperature, optionally followed by leaving the puree at 4° C. and/or (subsequently) at −20° C., till the puree temperature was room temperature, 4° C. or −20° C., as specified.

Sample production including the pasteurization for half an hour, followed by the conventionally applied relatively slow cooling step of method B, or for providing the further samples of Table 1 10-12 days old BSF larvae were washed with tap water and then minced using a blender. Then, larvae puree samples were pasteurized using a micro-cooker (bioreactor) for the indicated time (see Table 1) at the indicated temperature. During heating, the bioreactor was set at low speed (level 2). After pasteurization, samples that were cooled according to a conventional cooling method (method B, Table 1) were placed in an oven at 85° C. and every half-hour the oven temperature was decreased 5° C. for a total period of 2 hours (85° C. for 30 minutes, 80° C. for 30 minutes, 75° C. for 30 minutes and finally, 70° C. for 30 minutes). Next, samples were placed at room temperature and/or (subsequently) in the fridge (4° C.) for 19 hours. Last, samples were optionally placed in the freezer (−20° C.) for at least 12 hours. This slow step of cooling mimics the slow cooling at steady state (without flow, without stirring of the puree) that is applied at large scale (400 liter or more). Such a large batch is commonly left at ambient temperature without any stirring, shaking, swirling, pumping, etc., while at about 90° C. at the start. After a few hours, the batch is still left at ambient temperature (e.g. room temperature), or placed in a cooled warehouse or reefer, at for example 4° C. or −20° C. Due to the steady state of the initially hot puree, and at the lower temperatures, thereafter, the final temperature of a batch of puree of over 100 liter is only reached after 12 hours or more.

A sample D was produced by heating 400 liter of minced BSF larvae 10-12 days of age, at 90° C. for 30 minutes, followed by a relatively slow cooling step of leaving the puree at ambient temperature (room temperature) until room temperature was reached, followed by storage at 4° C. and/or storage at −20° C. The relatively slow cooling takes at least 12 hours, as indicated here above for mimicking slow cooling at industrial scale.

A sample D″ was produced at 400 liter scale, of minced BSF larvae 10-12 days of age, by the method of the invention. For applying the method at this scale, the cooling assembly 1 of FIG. 7 was applied. The 400 liter of minced larvae were pasteurized for 80 seconds at 90° C. (±2° C.), to provide the heated insect pulp of step (a) of the method. Subsequently, further using the cooling assembly 1, the 400 liter heated insect pulp was pre-cooled under flow to 35° C.-38° C. in about 3 minutes in step (b) of the method, using the counter current cooling according to the application of the more than two cooling units 7, 7a of the cooling assembly. The cooling medium in the outer pipe of the cooling units was tap water at a temperature of about 12° C. In step (c) of the method of the invention, the pre-cooled insect pulp is pumped into the double-jacket tank 19 (with cooling receptacle 14) and further cooled to about 3-6° C. in about 1 hour, under stirring of the pulp, using flowing water-glycol mixture circulating through the double jacket 20 in the circuit 31. The water-glycol mixture is chilled at a temperature of about −2.8° C., using a chiller 21′ (chilling unit 21′) that cools the mixture in a source 21 of the mixture. When the insect paste at 3-6° C. was provided, the tank 19 was emptied with a driver d10 and the insect paste was pumped to a storage container 30. The provided insect paste was subsequently stored at 4° C., and for some batches, subsequently frozen at −20° C. within 24 hours after the insect paste was provided with step (c) of the method of the invention.

After step (c) of the method of the invention, a homogeneous, highly viscous insect pulp was provided, with a dominant light brown/light gray surface color appearance. The insect paste had a texture reminiscent to porridge, with an evenly distributed granular texture in a wet puree-like matrix. The WHC is determined for the samples D″, as are the PDI and the dry matter content, the microbial count. In addition, the color of the insect paste is assessed and quantified according to the method outlined here below.

### Dry Matter & Moisture Content

To determine the dry matter content, first, the moisture content was determined in accordance with EC-152/2009. Then, dry matter was calculated by subtracting the moisture content (moisture mass) from the initial mass of the sample.

### Enterobacteriaceae—Presence in Insect Paste Samples

The method applied was according to NEN-ISO 21528-2.

### Aerobic Mesophilic Count—in Insect Paste Samples

The aerobic mesophilic count was performed in compliance with NEN-ISO 21528-2.

### Water Holding Capacity (WHC)

Insect paste samples of Table 1 were transferred to a container (200-ml plastic bucket), such that the insect paste covers the bottom but leaving at least one corner free from the paste. About 20 g of each sample was transferred to a separate container. The weight of the sample was measured at the beginning of the test, using a common lab scale. Next, all samples were heat treated at 121° C. for 80 minutes after closing the containers with an air-tight lid. Then, the sample containers were kept tilted at 30° angle from the horizontal for a time period of 2 minutes, such that free water could flow to the free corner of the container bottom side. Then, the water released from the samples was drained and the weight of the residual insect pulp product after water removal was recorded. The percentage by weight of water loss compared to the total initial weight of the insect paste before the heating step is applied (set to 100%), is used as a representation of the WHC of the sample: WHC=100% minus percentage by weight of water lost by the sample upon the heating step. That is to say, a WHC of 90% relates to a 10% by weight water loss from a sample of insect paste that has been heated for 80 minutes at 121° C. in an air-tight container.

### Protein Dispersibility Index (PDI)

The protein dispersibility test was performed according to AOCS Standard Procedure Ba 10-09 2017 (as in force in Q4-2020). The procedure was performed at room temperature. This method is used to determine the dispersible protein in soybean products under the conditions of the test. The procedure started transferring 10 g of an insect paste sample to a mixed cup containing 50 ml distilled water, which was at room temperature. Then, the mixture of water and paste was stirred to form a diluted paste using a spatula. Next, 100 ml of additional distilled water (at room temperature) were added gradually to the mixture while stirring. Once a smooth slurry was formed, the mixture was blended at 8,500 rpm for 10 minutes. For this blending, a blender with 5-cm blade assembly rotor knife at 8,500 rpm is used. After blending the mixture, it was transferred into a beaker and allowed to separate. Then, a decanted portion was taken and centrifuged at 8,500 rpm (1,400×g) for 10 minutes. The protein content of the supernatant was determined using the Dumas method (in accordance to NEN-EN-ISO 16634 (as in force in Q4-2020)), providing the percentage for the water dispersed protein based on the total weight of the paste. The protein content of the starting insect paste samples was also determined by the Dumas method (in accordance with NEN-EN-ISO 16634 (as in force in Q4-2020)), providing the percentage total protein in each paste sample, on a weight basis. Finally, the Protein Dispersibility Index (PDI) was calculated using the below formula:

Protein Dispersibility Index (PDI)=[% water dispersed protein×100]/[% total protein]

### Data Analysis

Average and standard deviation was performed for each of the two (n=2) or four replications (n=4) using Microsoft Excel.

### Statistical Analysis

T-test was used to compare the different treatment according to the different parameters. The test setting used was tail=2 and type=3. Microsoft Excel was used to perform this analysis. P-value<0.05 were considered significantly different.

### Colour Analysis

Insect pastes produced using the same batch of larvae (10 days old) but under different processing conditions (see Table 1) were evaluated for their differences in colour under influence of varying pasteurization time (method step (a); Table 1) and varying cooling steps thereafter (Table 1). First, all nine samples were taken from the −20° C. freezer (common final step of all insect paste treatments, for the color assessment) about 1-2 hrs previous to taking the pictures. After that time, about 3 grams of sample were spread in a plastic lid with the help of a spoon. To get an overview of the different colours present in each sample, pictures were taking from the inner core, upper surface and bottom surface of the different samples, having at least a total of 5 pictures for each treatment, i.e. each paste sample. The Stereomicroscope VisiScope series 300 (VWR, Leuven) was used to observe the insect paste samples. Pictures of the samples were taken using VisiCam 16 Plus camera (VWR International bvba, Leuven), which was incorporated in the Stereomicroscope. WaveImage was the software used by VisiCam 16 Plus camera to read and process the pictures. All pictures were taken under the same light conditions (using artificial light support from the right side of the microscope) and under the same zooming conditions (25×). The colour identification of each picture was identified using an online free tool, TinEye (website_services.tineve.com/MulticolorEngine). For each insect paste sample, a representative set of colour codes (Hex triplet) was identified after having the outcome of the TinEye tool. In order to do that, only colours that appears >2 in the 5 separate images were used to establish a pattern for that specific sample.

For the samples 1A, 2A and 3A, relatively light colors identified in the five images were selected by visual inspection, after applying the MultiColorEngine of TinEye. The percentage surface area of these relatively light colors compared to the surface area covered by the total of colors present in the samples, was calculated. The corresponding selected Hex triplets (hexadecimal color codes) were fed to the Colour picker tool of Google (assessed February 2021). A color codes area surrounding the selected Hex triplets was determined and selected, by picking four color codes of relatively light colors surrounding the selected color code, and defining the area of color codes by a set of four color code limits and straight lines between these color code limits, in the order top-left to top-right to bottom-right to bottom-left to top-left, encompassing the selected color code from the sample. For all further samples 1 B, 2B, 3B, 4A, 4B and D, the percentage of the presence of these selected relatively light colors in the samples, which were present in samples 1A, 2A, 3A, was determined and compared. This way, the relative presence (surface area with relatively light color compared to the total surface area) of relatively light colors in a sample serves as a measure for the combination of pasteurization method steps applied with an insect puree and subsequent cooling steps applied to the insect puree. The inventors established that the longer the pasteurization time, the less relatively light colored insect paste is provided (as assessed by determining the surface area having a relatively light color compared to the total surface area), when the cooling steps are kept constant, such as the cooling steps of the method of the invention. Moreover, at constant pasteurization time for provision of heated insect puree in step (a) of the method, e.g. a pasteurization time of 80 seconds, 160 seconds or 300 seconds, cooling applied according to the method of the invention provides relatively lighter insect paste (larger percentage of the insect paste surface area has a relatively light color, i.e. the selected light colors) than when a conventional, long lasting cooling procedure is applied. The inventors established that with a pasteurization time of 80 seconds-300 seconds, followed by the relatively fast 2-step cooling protocol according to the method of the invention, insect paste (BSF larvae paste) with a unique surface color pattern is obtained, not seen when the pasteurization time is extended and/or when the cooling is not applied according to the method of the invention (see Table 1).

Example for establishing the surface area of BSF larvae paste, having a relatively light color, with a specific hexadecimal color code (Hex triplet) and four boundary Hex triplets surrounding the center color code, wherein these five Hex triplets define the range of color codes for the paste.

For example, for sample 1A, in one of the five images taken from the surface of a sample of 3 g of sample 1A, the light-brown color with Hex triplet #a8744c was determined with the color identifier tool MultiColorEngine of TinEye. Subsequently, this code was entered in the Colour picker online tool of Google, which provided the surface area of similar colors surrounding #a8744c, as depicted in gray scale in the Scheme I, here below.

The Colour picker tool provides a colour area with, from top-left to top-right to bottom-right to bottom-left, the colour boundaries with Hex triplet codes #fffefc, #ff7003, #030100, #050505, respectively. For identifying insect paste batches that have a similar surface color as the insect paste provided by the method of the invention, the percentage of color similar to colors identified in the samples 1A and 2A, is determined. For this, it is determined for a certain batch of insect paste (BSF larvae paste) what the percentage of the surface area is that has a color with a color code within the color surface area defined by the boundaries #d6a987, #db9158, #945525 and #8a674c, as outlined in Scheme I, that surround the measured color code #a8744c.

Similar Schemes are determined for each relatively light color visible on the surface of the samples 1A and 2A, providing in total 12 further color surface area Schemes in addition to Scheme 1. The Schemes 1-13 are identified by their respective four boundary color codes (here #d6a987, #db9158, #945525 and #8a674c for Scheme 1, relating to color #a8744c).

### Results

### Dry Matter Content of BSF Larvae Paste (DM)

On average, there were no significant differences between dry matter content for the nine BSF larvae paste samples listed in Table 1. The DM content varied between 28% and 29% by weight based on the total weight of the samples. The DM content for Sample 1A was 28%, for Sample 1 B 28%, for Sample 4A 29% and for Sample 4B 28%. Samples 1A and 2A had a wet-like shiny appearance under direct light or when illuminated with white light. All samples were semi-solid pastes, which were pumpable. Samples 1A, 2A and 3A had a lower viscosity than the other samples as determined by assessing the relative tendency to be pourable. Samples 1A, 2A and 3A appeared as a homogeneous semi-solid paste, whereas the other samples had a dryer, aggregate-like appearances with a non-homogeneous texture and non-homogeneous size distribution. Separate aggregates were not visible in samples 1A and 2A.

The dry matter content of sample D′ was 28%. The dry matter content of sample D was 28%.

### Aerobic Mesophilic Count—in Insect Paste Samples

On average, results from total plate count reveal that no significant differences were apparent under influence of any insect puree treatment. That is to say, relatively short pasteurization in step (a) of the method (samples 1A, D), for providing heated insect puree, and/or relatively fast cooling in step (b) and (c) of the method (samples 1A, 4A), does provide similar aerobic mesophilic counts compared to insect paste provided by heating insect puree for 30 minutes at 90° C. (samples 4A, 4B) and/or cooling heated puree slowly (samples 1 B, 4B, D). These data show that by a relatively short pasteurization step of 80 seconds at 90° C., followed by a relatively fast cooling protocol of steps (b) and (c) of the method of the invention, in a relatively short time insect paste is provided with a similar aerobic mesophilic count when compared to insect paste provided by applying conventional methods of relatively long pasteurization for providing heated insect puree, and/or of relatively long-lasting slow cooling (leaving heated insect puree at ambient temperature until room temperature is achieved for the puree, or slowly cooling heated insect puree at ambient temperature from 90° C. to 70° C., followed by slow further cooling by storing a batch of puree at 4° C.).

TABLE 2
Aerobic mesophilic count - in insect paste samples

| Sample (See Table 1) | Total plate count (average of n = 4) |
|---|---|
| 1A | 3, 1 × 10E6 |
| 1B | 1, 9, 0 × 10E6 |
| 4A | 0, 7 × 10E6 |
| 4B | 0, 32 × 10E6 |
| D | Comparable to 1A, 1B, 4A, 4B |
| D″ | Comparable to 1A, 1B, 4A, 4B |

The aerobic mesophilic count was performed in compliance with NEN-ISO 21528-2.

### Enterobacteriaceae—Presence in Insect Paste Samples

On average, the Enterobacteriaceae load (cfu/g) in all samples of Table 1 was equal or below 10 (cfu/g). No significant differences were reported among any samples. These results show that by a relatively short pasteurization step of 80 seconds at 90° C., followed by a relatively fast cooling protocol of steps (b) and (c) of the method of the invention, in a relatively short time insect paste is provided with a similar Enterobacteriaceae load or count or burden, when compared to insect paste provided by applying conventional methods of relatively long pasteurization for providing heated insect puree, and/or of relatively long-lasting slow cooling (leaving heated insect puree at ambient temperature until room temperature is achieved for the puree, or slowly cooling heated insect puree at ambient temperature from 90° C. to 70° C., followed by slow further cooling by storing a batch of puree at 4° C.). The Enterobacteriaceae load (cfu/g) in Sample D″ is determined.

### Protein Dispersibility Index (PDI)

For the sample 1A (see Table 1) a significantly higher PDI is measured in comparison to samples 1B, 4A, 4B and D. On average, samples that resulted in higher values of PDI were 1A with levels above 40%, i.e. 46.0%. On average, samples 1 B (PDI=38.8%), 4A (PDI=37.3%) and 4B (PDI=35.8%) had PDI between <40 to >30. On average, D was the sample reporting lower PDI and with levels above 30% (PDI=31.6%). These results show that by a relatively short pasteurization step of 80 seconds at 90° C., followed by a relatively fast cooling protocol of steps (b) and (c) of the method of the invention, in a relatively short time insect paste is provided with a higher PDI, when compared to insect paste provided by applying conventional methods of relatively long pasteurization for providing heated insect puree (sample 4A), and/or of relatively long-lasting slow cooling (sample D, 1B, 4B) (leaving heated insect puree at ambient temperature until room temperature is achieved for the puree, or slowly cooling heated insect puree at ambient temperature from 90° C. to 70° C., followed by slow further cooling by storing a batch of puree at 4° C.). The PDI for Sample D″ is determined.

### Water Holding Capacity (WHC)

Table 3 displays the results of the WHC measurements for all samples displayed in Table 1, here expressed as the percentage water loss upon heating of the respective samples. Applying a relatively fast pasteurization process step for provision of heated insect puree in step (a) of the method of the invention, followed by the relatively fast 2-stage cooling steps according to method steps (b) and (c) of the method of the invention, provides insect paste with a relatively high WHC (low water loss), expressed as 100% minus the weight percentage water loss upon heating the sample according to the protocol outlined here above. That is to say, WHC is higher than 90% when the pasteurization time at 90° C. is 5 minutes (300 seconds) or shorter (80 seconds, 160 seconds), and when the cooling thereafter is applied according to the method of the invention: rapid cooling in minutes from 90° C. to 35° C. and subsequent relatively fast cooling to 4° C. in 2 hours or less. Longer pasteurization time decreases WHC (increases water loss). Slower cooling of heated insect puree decreases WHC (increases water loss). The combination of longer pasteurization time and slower cooling thereafter decreases WHC. The WHC is determined for the Sample D″.

TABLE 3
Water loss for nine samples according to Table 1, expressed
as the % relative water loss on a weight basis.

| Sample | R1 | R2 | R3 | R4 | Average | SD |
|---|---|---|---|---|---|---|
| 1A | 5.445545 | 5.164319 | 5.555556 | 6.392694 | 5.6395284 | 0.528445 |
| 1B | 11.71171 | 12.09302 | 11.73709 | 11.55556 | 11.774345 | 0.227109 |
| D | 11.11 | 10.95 | n.d. | n.d. | 11.03 | 0.113137 |
| 2A | 6.85 | 7.31 | 7.18 | 6.8 | 7.035 | 0.249065 |
| 2B | 13.93 | 13.43 | 12.44 | 14.15 | 13.4875 | 0.760543 |
| 3A | 9.45 | 9.66 | 9.5 | 9.6 | 9.5525 | 0.095 |
| 3B | 16.42 | 16.1 | 16.34 | 17.21 | 16.5175 | 0.481274 |
| 4A | 11.25541 | 11.37441 | 10.84906 | 10.87866 | 11.089384 | 0.265182 |
| 4B | 17.11712 | 18.34862 | 17.56098 | 18.04878 | 17.768874 | 0.542361 |

R1-R4: replicates
n.d.: not determined

### Surface Color of BSF Larvae Paste

As outlined here above, for the samples listed in Table 1 the surface area of the insect paste which had a relatively light color, with the relatively light colors for samples 1A and 2A and their respective color Schemes 1-13 as a reference, was scored and compared. For Sample 1A and 2A, the following 18 hexadecimal triplet color codes of relatively light colors were identified as being abundantly present: #6e4d44, #6e5046, #76574b, #82635a, #876560, #8c6a63, #906f62, #966f61, #a78a85, #a8744c, #a98670, #ae7038, #b69692, #ba978d, #bc9c96, #bd9d99, #bfa49d, #c9a9a3. Based on these 18 Hex triplets, 13 color Schemes 1-13 were construed (see Scheme 1 here above for an example). These 13 color schemes are:
Measured color #ba978d (established Scheme: #d6bcb4-#dba697-#875546-#73554d);
Measured color #82635a (established Scheme: #a68f88-#ad8072-#704b40-#6b5c58);
Measured color #6e4d44 (established Scheme: #ad8d84-#b58274-#6e4d44-#755b54);
Measured color #bfa49d (established Scheme: #ccb7b1-#cfa69b-#8f655a-#856d67);
Measured color #8c6a63 (established Scheme: #c7a69f-#c78d81-#734a41-#6e5651);
Measured color #6e5046 (established Scheme: #a6887c-#a3664e-#754836-#76574b);
Measured color #76574b (established Scheme: #d9ad9c-#d47b59-#6b4333-#705d55);
Measured color #906f62 (established Scheme: #b5988d-#b88672-#7d5748-#8a6c60);
Measured color #966f61 (established Scheme: #c7a497-#c28772-#85503d-#966f61);
Measured colors #876560, #a78a85, #b69692, #bd9d99, #c9a9a3, #bc9c96 (established Scheme: #c9afab-#d69992-#b69692-#82716f);
Measured color #a8744c (established Scheme: #d6a987-#db9158-#945525-#8a674c) (=Scheme 1);
Measured color #a98670 (established Scheme: #c2a491-#c47e52-#8a512d-#876f60); and
Measured color #ae7038 (established Scheme: #d6a476-#c9803e-#855122-#946c48).

For the measured colors #876560, #a78a85, #b69692, #bd9d99, #c9a9a3 and #bc9c96, no separate color Schemes were drawn, since each separate Scheme for each individual color code in this range of codes overlaps largely with all other Schemes. A single Scheme for this series of color codes sufficies to sufficiently cover the color code surface area space. In the established Schemes, the four color codes define a color code range within the boundaries defined by the four codes and the lines drawn between them, as outlined here above.

For Sample 3A, the following colors indicated with their hexadecimal color codes were identified in five separate images of the Sample 3A surface area, which color codes fall within the established relatively light color Schemes 1-13 as outlined here above: 78605e, 8e6e68, 937470, bea2a0, 937879, dabdba, al 837d, cbafab, 935f39. In Sample 1 A and Sample 2A, the relatively light colors, selected for composing the color ranges of Schemes 1-13, are in the range of light-brown to light gray-brown, light liver color/gray/pink, light vanilla/gray/brown.

TABLE 4
Relative surface area of black soldier fly paste
having a predetermined relatively light color

| Sample | Relative surface area having a light color (%) |
|---|---|
| 1A | 83 |
| 1B | <20 |
| D | <35 |
| 2A | 59 |
| 2B | <40 |
| 3A | 64 |
| 3B | <20 |
| 4A | <40 |
| 4B | <40 |

For each insect paste sample, color was determined in five different surface areas of the same sample

These results show that by a relatively short pasteurization step of 80 seconds, 160 seconds or 300 seconds at 90° C., followed by a relatively fast cooling protocol of steps (b) and (c) of the method of the invention, in a relatively short time insect paste is provided with a relatively lighter color, when compared to insect paste provided by applying conventional methods of relatively long pasteurization (30 minutes) for providing heated insect puree (sample 4A), and/or of relatively long-lasting slow cooling (sample D, 1 B, 2B, 3B, 4B) (leaving heated insect puree at ambient temperature until room temperature is achieved for the puree, or slowly cooling heated insect puree at ambient temperature from 90° C. to 70° C., followed by slow further cooling by storing a batch of puree at 4° C.). The quantification of the color of Sample D″ is established.

1. An insect paste with a water holding capacity (WHC) of 90% or higher by weight of the insect paste, wherein the WHC is expressed as 100% minus the weight percentage of water that is released from the insect paste during a heating step based on the total weight of the insect paste before being subjected to this heating step, and wherein the heating step comprises subjecting the insect paste to a temperature of 121° C. for 80 minutes.

2. The insect paste of claim 1, wherein the insect paste has a WHC in the range 91% by weight-97% by weight, based on the total weight of the insect paste.

3. The insect paste of claim 1, wherein the insect paste has a protein dispersibility index (PDI) of at least 42% by weight based on the total weight of the insect paste, wherein the protein dispersibility index is determined according to AOCS Standard Procedure Ba 10-09 2017 and wherein, in accordance with the AOCS Standard Procedure Ba 10-09 2017, protein content is determined with the Dumas method in accordance with NEN-EN-ISO 16634, such as a PDI of 42-560% by weight.

4. The insect paste of claim 1, wherein at least 55% surface area of the insect paste has a color pattern comprising any one or more of hexadecimal color codes (Hex triplets) selected from the range of Hex triplets encompassed by thirteen color code areas that are each defined by at least a single color code and a set of four color code limits and straight lines between these color code limits, in the order top-left to top-right to bottom-right to bottom-left to top-left (single color code(s) in each defined color code area in brackets):
#d6bcb4-#dba697-#875546-#73554d (#ba978d);
#a68f88-#ad8072-#704b40-#6b5c58 (#82635a);
#ad8d84-#b58274-#6e4d44-#755b54 (#6e4d44);
#ccb7b1-#cfa69b-#8f655a-#856d67 (#bfa49d);
#c7a69f-#c78d81-#734a41-#6e5651 (#8c6a63);
#a6887c-#a3664e-#754836-#76574b (#6e5046);
#d9ad9c-#d47b59-#6b4333-#705d55 (#76574b);
#b5988d-#b88672-#7d5748-#8a6c60 (#906f62);
#c7a497-#c28772-#85503d-#966f61 (#966f61);
#c9afab-#d69992-#b69692-#82716f (#876560, #a78a85, #b69692, #bd9d99, #c9a9a3, #bc9c96);
#d6a987-#db9158-#945525-#8a674c (#a8744c);
#c2a491-#c47e52-#8a512d-#876f60 (#a98670); and
#d6a476-#c9803e-#855122-#946c48 (#ae7038).

5. The insect paste of claim 1, wherein at least 70% surface area of the insect paste has a color pattern comprising any one or more of hexadecimal color codes (Hex triplets) selected from the range of Hex triplets encompassed by thirteen color code areas that are each defined by at least a single color code and a set of four color code limits and straight lines between these color code limits, in the order top-left to top-right to bottom-right to bottom-left to top-left (single color code(s) in each defined color code area in brackets):
#d6bcb4-#dba697-#875546-#73554d (#ba978d);
#a68f88-#ad8072-#704b40-#6b5c58 (#82635a);
#ad8d84-#b58274-#6e4d44-#755b54 (#6e4d44);
#ccb7b1-#cfa69b-#8f655a-#856d67 (#bfa49d);
#c7a69f-#c78d81-#734a41-#6e5651 (#8c6a63);
#a6887c-#a3664e-#754836-#76574b (#6e5046);
#d9ad9c-#d47b59-#6b4333-#705d55 (#76574b);
#b5988d-#b88672-#7d5748-#8a6c60 (#906f62);
#c7a497-#c28772-#85503d-#966f61 (#966f61);
#c9afab-#d69992-#b69692-#82716f (#876560);
#a78a85, #b69692, #bd9d99, #c9a9a3, #bc9c96);
#d6a987-#db9158-#945525-#8a674c (#a8744c);
#c2a491-#c47e52-#8a512d-#876f60 (#a98670); and
#d6a476-#c9803e-#855122-#946c48 (#ae7038).

6. The insect paste of claim 1, wherein the insect is black soldier fly larvae, wherein said larvae are 6 days-30 days of age, and/or wherein said larvae are at an age 12 hours-3 days before the larvae transform into prepupae.

7. The insect paste of claim 1, wherein the insect paste can be prepared by the steps of:
(a) providing a heated insect pulp that is at a temperature of 45° C. or higher;
(b) cooling the heated insect pulp of step (a) in a first cooling phase to a temperature of 45° C.-35° C. within a first time period, therewith providing pre-cooled insect pulp; and
(c) cooling the pre-cooled insect pulp of step (b) to a temperature of below 35° C. in a second cooling phase that starts within a second time period starting at the end of the first time period of step (b), and that lasts for a third time period.

8.-9. (canceled)

10. The insect paste of claim 7, wherein the heated insect pulp can be prepared by the steps of:
(i) providing insects, preferably insects that are washed, preferably washed with water;
(ii) preparing a pulp from the insects of process step (i); and
(iii) heating the insect pulp of process step (ii) for 50 seconds-1 hour at a temperature of 60° C.-100° C., preferably 85° C.-95° C., therewith providing the heated insect pulp of step (a) of the method.

11.-52. (canceled)

53. The insect paste of claim 10, wherein in the heated insect pulp is heated for 10 minutes or less, at a temperature of 80° C.-100° C.

54. A food product, food ingredient, feed product or feed ingredient comprising an insect paste comprising:
a water holding capacity (WHC) of 90% or higher by weight of the insect paste, where the WHC is expressed as 100% minus the weight percentage of water that is released from the insect paste during a heating step based on the total weight of the insect paste before being subjected to this heating step, and wherein the heating step comprises subjecting the insect paste to a temperature for 121° C. for 80 minutes.

55. The food product, food ingredient, feed product or feed ingredient of claim 54, wherein the insect paste the can be prepared by the steps of:
(a) providing a heated insect pulp that is at a temperature of 45° C. or higher;
(b) cooling the heated insect pulp of step (a) in a first cooling phase to a temperature of 45° C.-35° C. within a first time period, therewith providing pre-cooled insect pulp; and
(c) cooling the pre-cooled insect pulp of step (b) to a temperature of below 35° C. in a second cooling phase that starts within a second time period starting at the end of the first time period of step (b), and that lasts for a third time period.

56. The food product, food ingredient, feed product or feed ingredient of claim 55, wherein the heated insect pulp can be prepared by the steps of:
(i) providing insects, preferably insects that are washed, preferably washed with water;
(ii) preparing a pulp from the insects of process step (i); and
(iii) heating the insect pulp of process step (ii) for 50 seconds-1 hour at a temperature of 60° C.-100° C., preferably 85° C.-95° C., therewith providing the heated insect pulp of step (a) of the method.

57. The food product, food ingredient, feed product or feed ingredient of claim 56, wherein the heated insect pulp is heated for 10 minutes or less, at a temperature of 80° C.-100° C.
